(19) United States
(12) Patent Application Publication
(10) Pub. No.: US 2025/0258378 A1
(43) Pub. Date: Aug. 14, 2025

(54) EMBEDDED IMAGE PIPE

(71) Applicant: LUMUS LTD., NESS ZIONA (IL)

(72) Inventors: Elad SHARLIN, Mishmar David (IL); Ronen CHRIKI, Lod (IL)

(73) Assignee: LUMUS LTD., NESS ZIONA (IL)

(21) Appl. No.: 19/099,101

(22) PCT Filed: Jul. 28, 2023
(86) PCT No.: PCT/IB2023/057695

§ 371 Date: Jan. 28, 2025

Related U.S. Application Data
(60) Provisional application No. 63/392,904, filed on Jul. 28, 2022.

(51) Int. Cl. G02B 27/01; G02B 5/30; G02B 27/00; G02B 27/28; G02B 27/30

(52) U.S. Cl. CPC G02B 27/0172; G02B 5/3016; G02B 27/0081; G02B 27/0176; G02B 27/283; G02B 27/286; G02B 27/30

(57) ABSTRACT

An optical device may include a coupling assembly configured to receive a collimated image beam and provide a first output image beam and a second output image beam; an image pipe configured to receive the first output image beam at an image pipe input and provide at least one propagated image beam at an image pipe output; a first waveguide having a first waveguide rear surface, the first waveguide configured to receive the second output image beam and emit a first expanded output image beam from the first waveguide rear surface; and a second waveguide having a second waveguide rear surface, the second waveguide configured to receive the at least one propagated image beam and emit a second expanded output image beam from the second waveguide rear surface.

### CROSS-REFERENCE TO RELATED APPLICATION

This application is based upon and claims the benefit of priority under 35 USC 119(e) of U.S. patent application Ser. No. 63/392,904 filed on Jul. 28, 2022, and titled Embedded Image Pipe, the entire disclosure of which is herein incorporated by reference in its entirety.

### BACKGROUND

Unless otherwise indicated herein, the materials described in this section are not prior art to the claims in this application and are not admitted to be prior art by inclusion in this section. The present disclosure relates in general to systems, devices, and methods of presenting optical information, more particularly, to head mounted displays (HMDs) and smart glasses (SGs) with near eye displays (NEDs) for presenting optical information to a user.

Conventional wearable optical devices, such as head mounted optical displays and smart glasses with near eye displays, are typically large and often are also heavy. Such devices may also suffer from a limited field of view (FoV) as well as performance limitations based on limited options for injecting images which sometimes may require large input apertures. This can limit the usability of such devices. Further, electronic components that drive these HMDs and SGs typically consume significant power leading to lower battery life, and yet still these devices may provide unclear augmented images, for example. What is needed are solutions that address these issues, and others.

### SUMMARY

According to an example, an optical device is generally described. The optical device may include a coupling assembly configured to receive a collimated image beam and provide a first output image beam and a second output image beam; an image pipe configured to receive the first output image beam at an image pipe input and provide at least one propagated image beam at an image pipe output; a first waveguide having a first waveguide rear surface, the first waveguide configured to receive the second output image beam and emit a first expanded output image beam from the first waveguide rear surface; and a second waveguide having a second waveguide rear surface, the second waveguide configured to receive the at least one propagated image beam and emit a second expanded output image beam from the second waveguide rear surface.

According to this example, the optical device wherein the coupling assembly further comprises: a semitransparent mirror having a semitransparent mirror first surface and a semitransparent mirror second surface opposite the semitransparent mirror first surface, the semitransparent mirror first surface configured to receive the collimated image beam and provide the first output image beam reflected from the semitransparent mirror first surface and provide the second output image beam emitted from the semitransparent mirror second surface. The optical device wherein the first waveguide comprises a first waveguide first aperture expander and a first waveguide second aperture expander, the first waveguide first aperture expander being configured to expand the second output image beam and provide a first waveguide first plurality of expanded image beams directed to the first waveguide second aperture expander configured to expand the first waveguide first plurality of expanded image beams and provide a first waveguide second plurality of expanded image beams to be emitted as the first expanded output image beam; wherein the second waveguide comprises a mirror configured to receive the at least one propagated image beam and provide a reflected at least one propagated image beam, the second waveguide further comprising a second waveguide first aperture expander and a second waveguide second aperture expander, the second waveguide first aperture expander being configured to expand the reflected at least one propagated image beam and provide a second waveguide first plurality of expanded image beams directed to the second waveguide second aperture expander configured to expand the second waveguide first plurality of expanded image beams and provide a second waveguide second plurality of expanded image beams to be emitted as the second expanded output image beam. The optical device may further include an image projector configured to provide the collimated image beam based on a digital image, wherein the collimated image beam is collimated to infinity, and wherein the projector includes a liquid crystal on silicon display.

According to another example, an optical system is generally described. An optical system may include an image projector configured to provide a collimated image beam based on a digital image; a coupling assembly configured to receive the collimated image beam and provide a first output image beam and a second output image beam; an image pipe configured to receive the first output image beam at an image pipe input and provide at least one propagated image beam at an image pipe output; a first waveguide having a first waveguide rear surface, the first waveguide configured to receive the second output image beam and emit a first expanded output image beam from the first waveguide rear surface; and a second waveguide having a second waveguide rear surface, the second waveguide configured to receive the at least one propagated image beam and emit a second expanded output image beam from the second waveguide rear surface.

According to this example, the optical system wherein at least one of: the collimated image beam is collimated to infinity; the projector includes one of a liquid crystal display, a liquid crystal on silicon display, an organic light emitting diode display, a micro light emitting diode display, and a laser display; the image pipe includes at least one of a glass material, an acrylic material, and a polycarbonate material; a portion of the first waveguide is affixed to a portion of the image pipe with a layer of low refractive index adhesive; and the image pipe is an elongated transparent member having a first end and a second end with a rectangular cross section and orthogonal walls, the image pipe configured to receive at least one input image beam and provide four replicated output image beams based on the at least one input image beam. The optical system wherein the coupling assembly comprises a semitransparent mirror having a semitransparent mirror first surface and a semitransparent mirror second surface opposite the semitransparent mirror first surface, the semitransparent mirror first surface configured to receive the collimated image beam and provide the first output image beam reflected from the semitransparent mirror first surface and to provide the second output image beam emitted from the semitransparent mirror second surface; and wherein the first waveguide comprises a first waveguide first aperture expander and a first waveguide second aperture expander, the first waveguide first aperture expander being configured to expand the second output image beam and provide a first waveguide first plurality of expanded image beams directed to the first waveguide second aperture expander configured to expand the first waveguide first plurality of expanded image beams and provide a first waveguide second plurality of expanded image beams to be emitted as the first expanded output image beam; wherein the second waveguide comprises a mirror configured to receive the at least one propagated image beam and provide a reflected at least one propagated image beam, the second waveguide further comprising a second waveguide first aperture expander and a second waveguide second aperture expander, the second waveguide first aperture expander being configured to expand the reflected at least one propagated image beam and provide a second waveguide first plurality of expanded image beams directed to the second waveguide second aperture expander configured to expand the second waveguide first plurality of expanded image beams and provide a second waveguide second plurality of expanded image beams to be emitted as the second expanded output image beam.

According to this example, the optical system wherein the coupling assembly comprises: a polarizing beam splitter having a polarizing beam splitter first side and a polarizing beam splitter second side opposite the polarizing beam splitter first side, the polarizing beam splitter first side being configured to receive the collimated image beam and provide the first output image beam from the polarizing beam splitter first side and provide a transmitted image beam from the polarizing beam splitter second side; and a half wave plate having a half wave plate first side and a half wave plate second side, the half wave plate being configured to receive the transmitted image beam at the half wave plate first side and provide the second output image beam from the half wave plate second side. The optical system wherein the first waveguide comprises a first waveguide first aperture expander and a first waveguide second aperture expander, the first waveguide first aperture expander being configured to expand the second output image beam and provide a first waveguide first plurality of expanded image beams directed to the first waveguide second aperture expander configured to expand the first waveguide first plurality of expanded image beams and provide a first waveguide second plurality of expanded image beams to be emitted as the first expanded output image beam; and wherein the second waveguide comprises a second waveguide first aperture expander and a second waveguide second aperture expander, the second waveguide first aperture expander being configured to expand the at least one propagated image beam and provide a second waveguide first plurality of expanded image beams directed to the second waveguide second aperture expander configured to expand the second waveguide first plurality of expanded image beams and provide a second waveguide second plurality of expanded image beams to be emitted as the second expanded output image beam.

According to this example, the optical system wherein the coupling assembly further comprises: an active half wave plate liquid crystal element configured to receive the collimated image beam and provide a transformed image beam; a polarizing beam splitter having a polarizing beam splitter first side and a polarizing beam splitter second side opposite the polarizing beam splitter first side, the polarizing beam splitter first side being configured to receive the transformed image beam and provide the first output image beam from the polarizing beam splitter first side and provide a transmitted image beam from the polarizing beam splitter second side; and a half wave plate having a half wave plate first side and a half wave plate second side, the half wave plate being configured to receive the transmitted image beam on the half wave plate first side and provide the second output image beam from the half wave plate second side. The optical system wherein the first waveguide comprises a first waveguide first aperture expander and a first waveguide second aperture expander, the first waveguide first aperture expander being configured to expand the second output image beam and provide a first waveguide first plurality of expanded image beams directed to the first waveguide second aperture expander configured to expand the first waveguide first plurality of expanded image beams and provide a first waveguide second plurality of expanded image beams to be emitted as the first expanded output image beam; wherein the second waveguide comprises a mirror configured to receive the at least one propagated image beam and provide a reflected at least one propagated image beam, the second waveguide further comprising a second waveguide first aperture expander and a second waveguide second aperture expander, the second waveguide first aperture expander being configured to expand the reflected at least one propagated image beam and provide a second waveguide first plurality of expanded image beams directed to the second waveguide second aperture expander configured to expand the second waveguide first plurality of expanded image beams and provide a second waveguide second plurality of expanded image beams to be emitted as the second expanded output image beam.

According to this example, the optical system wherein the first waveguide comprises a first waveguide first aperture expander and a first waveguide second aperture expander, the first waveguide first aperture expander being configured to expand the second output image beam and provide a first waveguide first plurality of expanded image beams directed to the first waveguide second aperture expander configured to expand the first waveguide first plurality of expanded image beams and provide a first waveguide second plurality of expanded image beams to be emitted as the first expanded output image beam; and wherein the second waveguide comprises a second waveguide first aperture expander and a second waveguide second aperture expander, the second waveguide first aperture expander being configured to expand the at least one propagated image beam and provide a second waveguide first plurality of expanded image beams directed to the second waveguide second aperture expander configured to expand the second waveguide first plurality of expanded image beams and provide a second waveguide second plurality of expanded image beams to be emitted as the second expanded output image beam. The optical system wherein the image pipe is a first image pipe and wherein the first waveguide includes a first waveguide front surface that is opposite the first waveguide rear surface, the optical system further comprising: a third waveguide having a third waveguide rear surface, the third waveguide configured to receive the second output image beam and emit a third expanded output image beam from the third waveguide rear surface, the third waveguide rear surface being affixed to the first waveguide front surface, the third waveguide comprising: a second image pipe configured to receive the second output image beam and provide at least one propagated third image beam at a third image pipe output; a third waveguide first aperture expander, the third waveguide first aperture expander configured to expand the at least one propagated third image beam and provide a third waveguide first plurality of expanded image beams; and a third waveguide second aperture expander configured to expand the first plurality of expanded image beams and provide a third waveguide second plurality of expanded image beams to be emitted as the third expanded output image beam, the second image pipe configured to surround at least a portion of the third waveguide second aperture expander. The optical system further comprising: a frame configured to support the image projector, the coupling assembly, the image pipe, the first waveguide and the second waveguide, the frame being configured to conceal the image pipe within a portion of the frame.

According to yet another example, an optical system may include an image projector configured to provide a collimated image beam based on a digital image; a coupling assembly configured to receive the collimated image beam and provide a first output image beam and a second output image beam; a first image pipe configured to receive the first output image beam at a first image pipe input and provide an at least one first propagated image beam at a first image pipe output; a second image pipe configured to receive the second output image beam at a second image pipe input and provide an at least one second propagated image beam at a second image pipe output; a first waveguide having a first waveguide rear surface, the first waveguide configured to receive the at least one second propagated image beam and emit a first expanded output image beam from the first waveguide rear surface; and a second waveguide having a second waveguide rear surface, the second waveguide configured to receive the at least one first propagated image beam and emit a second expanded output image beam from the second waveguide rear surface.

According to this example, the optical system wherein the coupling assembly comprises: an active half wave plate liquid crystal element configured to receive the collimated image beam and provide a transformed image beam; a polarizing beam splitter having a polarizing beam splitter first side and a polarizing beam splitter second side opposite the polarizing beam splitter first side, the polarizing beam splitter first side being configured to receive the transformed image beam and provide the second output image beam from the polarizing beam splitter first side and provide a transmitted image beam from the polarizing beam splitter second side; a quarter wave plate having a quarter wave plate first side and a quarter wave plate second side, the quarter wave plate being configured to receive the transmitted image beam on the quarter wave plate first side and provide a converted image beam from the quarter wave plate second side; and a mirror having a reflective mirror surface configured to receive the converted image beam and provide a reflected image beam, the quarter wave plate configured to receive the reflected image beam on the quarter wave plate second side and provide a second converted image beam from the quarter wave plate first side, the polarizing beam splitter configured to receive the second converted image beam on the polarizing beam splitter second side and provide the first output image beam.

According to this example, the optical system wherein the first waveguide comprises a first mirror configured to receive the at least one second propagated image beam and provide a reflected at least one second propagated image beam, the first waveguide further comprising a first waveguide first aperture expander and a first waveguide second aperture expander, the first waveguide first aperture expander being configured to expand the reflected at least one second propagated image beam and provide a first waveguide first plurality of expanded image beams directed to the first waveguide second aperture expander configured to expand the first waveguide first plurality of expanded image beams and provide a first waveguide second plurality of expanded image beams to be emitted as the first expanded output image beam; wherein the second waveguide comprises a second mirror configured to receive the at least one first propagated image beam and provide a reflected at least one first propagated image beam, the second waveguide further comprising a second waveguide first aperture expander and a second waveguide second aperture expander, the second waveguide first aperture expander being configured to expand the reflected at least one first propagated image beam and provide a second waveguide first plurality of expanded image beams directed to the second waveguide second aperture expander configured to expand the second waveguide first plurality of expanded image beams and provide a second waveguide second plurality of expanded image beams to be emitted as the second expanded output image beam. The optical system wherein the first waveguide includes a first waveguide front surface that is opposite the first waveguide rear surface, the optical system further comprising: a third waveguide having a third waveguide rear surface, the third waveguide configured to receive the at least one second propagated image beam and emit a third expanded output image beam from the third waveguide rear surface, the third waveguide rear surface being affixed to the first waveguide front surface, the third waveguide comprising: a third image pipe configured receive the at least one second propagated image beam and provide an at least one propagated third image beam at a third image pipe output; a third waveguide first aperture expander, the third waveguide first aperture expander configured to expand the at least one propagated third image beam and provide a third waveguide first plurality of expanded image beams; and a third waveguide second aperture expander configured to expand the first plurality of expanded image beams and provide a third waveguide second plurality of expanded image beams to be emitted as the third expanded output image beam, the second image pipe configured to surround at least a portion of the third waveguide second aperture expander, the second image pipe having a homogenizing layer.

According to this example, the optical system wherein the second waveguide includes a second waveguide front surface that is opposite the second waveguide rear surface, the optical system further comprising: a polarizing beam splitter having a polarizing beam splitter first side and a polarizing beam splitter second side opposite the polarizing beam splitter first side, the polarizing beam splitter first side being configured to receive the at least one first propagated image beam and provide a second transmitted image beam from the polarizing beam splitter second side; a half wave plate having a half wave plate first side and a half wave plate second side, the half wave plate being configured to receive the second transmitted image beam on the half wave plate first side and provide a second converted image beam from the half wave plate second side; a fourth waveguide having a fourth waveguide rear surface, the fourth waveguide configured to receive the second converted image beam and emit a fourth expanded output image beam from the fourth waveguide rear surface, the fourth waveguide rear surface being affixed to the second waveguide front surface, the fourth waveguide comprising: a fourth image pipe configured to receive the second converted image beam and provide an at least one propagated fourth image beam at a fourth image pipe output; a fourth waveguide first aperture expander, the fourth waveguide first aperture expander configured to expand the at least one propagated first image beam and provide a fourth waveguide first plurality of expanded image beams; and a fourth waveguide second aperture expander configured to expand the fourth plurality of expanded image beams and provide a fourth waveguide second plurality of expanded image beams to be emitted as the fourth expanded output image beam, the fourth image pipe configured to surround at least a portion of the fourth waveguide second aperture expander, the fourth image pipe including a homogenizing layer. The optical system further comprising: a frame configured to support the image projector, the coupling assembly, the first image pipe, the second image pipe, the first waveguide and the second waveguide, the frame being configured to conceal the first image pipe and the second image pipe within a portion of the frame.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings and the description, like reference numbers and/or like element names may indicate identical or functionally similar elements.

### BRIEF DESCRIPTION OF THE DRAWINGS

FIG. 1 illustrates a block diagram of an optical system, in accordance with various examples of the present disclosure.

FIG. 2 illustrates an end view of an image pipe, in accordance with various examples of the present disclosure.

FIGS. 3A-3C illustrate details regarding an optical system, in accordance with various examples of the present disclosure.

FIGS. 4A-4B illustrate details regarding an optical system, in accordance with various examples of the present disclosure.

FIGS. 5A-5B illustrate details regarding an optical system, in accordance with various examples of the present disclosure.

FIGS. 6A-6B illustrate details regarding an optical system, in accordance with various examples of the present disclosure.

FIGS. 7A-7C illustrate details regarding an optical system, in accordance with various examples of the present disclosure.

FIGS. 8A-8C illustrate details regarding an optical system, in accordance with various examples of the present disclosure.

FIGS. 9A-9C illustrate details regarding an optical system, in accordance with various examples of the present disclosure.

FIGS. 10A-10H illustrate details regarding various configurations of optical systems, in accordance with various examples of the present disclosure.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

To be described in more detail below, a wearable device, such as a near eye display and/or smart glasses, can be implemented by a system and method described in accordance with the present disclosure. The system can efficiently provide high quality optical information to a user in various applications.

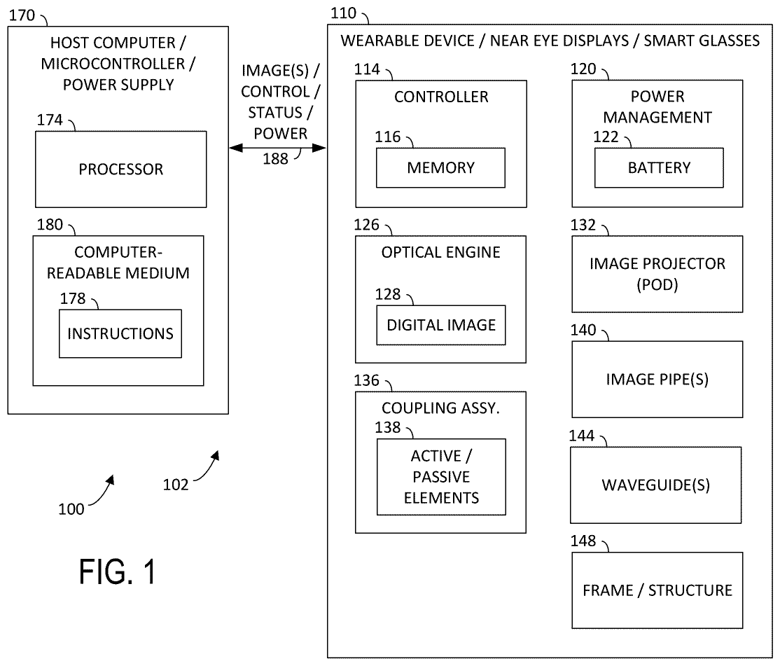

FIG. 1 illustrates a block diagram of an optical system, in accordance with various examples of the present disclosure. Optical system 100 may include two or more devices or components. Optical system 100 may be implemented generally as a hybrid system including various electronic, optical, and electro-optical elements. An optical device 102 may include one or more elements from optical system 100. To be described in more detail below, an optical system 100 may include a wearable device 110, such as one or more near eye displays configured separately or together as smart glasses, which may be worn on or about the head of a user to convey optical information to one or more eyes of a user.

Wearable device 110 may include a controller 114 with a memory 116 where controller 114 may be configured to send and receive electrical signals to various other elements in optical system 100, to execute program instructions stored in memory 116 in order to process and provide information, to operate wearable device 110, and to interact with other systems outside wearable device 110, for example. Controller 114 may include a microcontroller, a processor, various discrete components, programmable logic devices, and/or various interface circuits that may access memory 116 which may be removable, replaceable, programmable, and reprogrammable to update instructions to controller 114.

Wearable device 110 may also include a power management module 120 having a battery 122 configured to provide power, where power management module 120 may be configured to charge, discharge, and monitor power usage for battery 122. Various elements of wearable device 110 may receive power and/or control signals, including controller 114, an image projector 132, an optical engine 126, and various active element 138 in one or more coupling assemblies 136, for example. Various coupling assemblies 136 may include one or more cube beam splitters, semitransparent mirrors, polarizing beam splitters, a half wave plates (e.g., half-wavelength retardation plates), quarter wave plates (e.g., to convert linearly polarized light into circularly polarized light and vice versa), and the like. Various active elements 138 may include electronically controllable active half wave plate liquid crystal (AHWP LC) elements, and the like.

Image projector(s) 126, may also described as a compact image projector, a micro-display projector, or a projecting optical device (POD), may be configured to produce a collimated image beam based on a digital image 128. The collimated image beam may be collimated to infinity. The collimated image beam may be generated by various projecting optical devices, including a spatial light modulator (SLM) providing a two-dimensional (2D) array of pixel elements, each of the pixel elements being controllable to modulate a property, typically polarization, of light transmitted or reflected by the pixel element. An example of a transmitted light SLM is a liquid crystal display (LCD), while an example of a reflective SLM is a liquid crystal on silicon (LCOS) device or a digital light processing (DLP) device. Image projector 126 may include a liquid crystal display (LCD), a liquid crystal on silicon (LCoS) display, an organic light emitting diode (OLED) display, a micro light emitting diode (Micro-LED) display, and a laser display (LD), or the like. The representations described herein illustrate emission and progression of an image beam along an optical path, but it will be appreciated that this optical path can be folded, reflected, split, and further modulated by various active or passive elements, as described below. In this manner, the collimated image beam may be an illuminated representation of the digital image having an image field which is a two-dimensional representation of the digital image based on either a single graphical image (e.g., a static image) or a sequence of graphical images (e.g., a moving image) corresponding to different points within an image field that may be propagated through various optical elements in optical system 100. The term beam may also be used to refer to a ray, such as an image ray, herein. Commonly, a beam may refer to a coherent ray that may be emitted from a coherent source, such as a LASER, for example. As used herein, the terms ray and beam may be used almost synonymously in some circumstances.

Wearable device 110 may also include one or more waveguides 144 such as light-guide optical elements 144 (e.g., LOEs) comprising transparent materials configured to receive, propagate, and emit illumination related to the digital image in proximity to an eye of a user for the purpose of communicating information. For example, the transparent material comprising waveguide 144 may include optical glass or other suitable material that may be transformed into complex or compound optical structures using a process that may include coating, stacking, slicing, polishing, assembling, and shaping the transparent materials. The process may include the addition of partially reflective or fully reflective materials such as mirror coatings, and/or low index of reflection (LRI) adhesives or glues to assemble various elements together, for example. By preparing and assembling elements using low index of reflection adhesives, various elements may be fabricated and tested separately prior to assembly, which may reduce cost.

Optical engine 126 may be operably coupled to image projector 132 in order to provide power and control signals and to receive status signals, for example. Optical engine 126 may be configured to operate image projector 132 under the direction of the controller 114. For example, optical engine 126 may perform graphics processing for modifying digital image 128 before projection of an illuminated representation of the digital image by image projector 132. Image projector 132 may be coupled with the one or more waveguides 144 by one or more coupling assemblies 136 having one or more active and/or passive elements 138. Coupling assembly 136 may include one or more active elements such as an active half wave plate liquid crystal (AHWP LC) element, an active half wave plate, or a spatial light modulator (SLM), for example. Coupling assembly 136 may also include one or more passive elements such as one or more fully reflective mirrors, one or more partially reflective (e.g., semitransparent) mirrors, one or more half wave plates, one or more quarter wave plates, and various optical coatings which may be disposed between or upon various optical elements.

Wearable device 110 may also include a frame 148 (e.g., a head-mounted structure) for supporting and retaining one or more elements in wearable device 110. For example, frame 148 may directly or indirectly support and retain image projector 126 in a position next one or more image pipes 140 and one or more waveguides 144. In this manner, frame 148 may support and retain an optical engine 126, an image projector 132 and one or waveguides 144 on or about the head of a user, for example. References are made herein regarding the orientation of various elements relative to each other. Such references may also include reference to various elements of wearable device 110 when supported by frame 148 or in reference to a three-dimensional (3D) reference (e.g., X, Y, Z axes), as may be described in various drawing figures.

Optical system 100 may also include a host computer 170 that may include a processor 174 configured to read and execute operations based on pre-programmed instructions 178 stored in a computer-readable medium 180. Instructions 178 may include at least some instructions provided to controller 114 and stored in memory 116. Host computer 170 may communicate with one or more elements of wearable device 110 over a signal and power bus 188. In this manner, host computer 170 may provide power to charge battery 122, provide instructions to and receive status from controller 114, to control various other elements of wearable device 110, and to provide digital image data to optical engine 126.

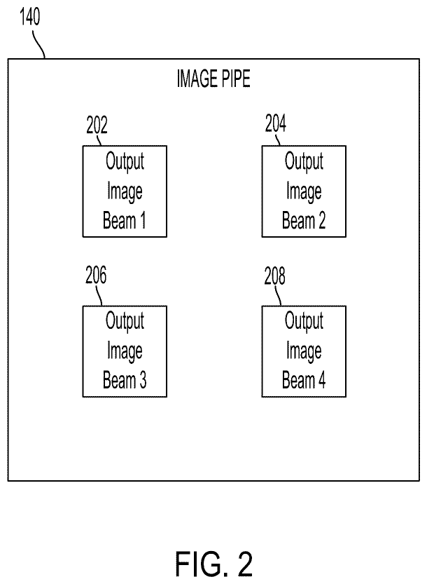

FIG. 2 illustrates an end view of an image pipe, in accordance with various examples of the present disclosure. As illustrated in an idealized form, an image pipe 140 may be an elongated transparent member having a first end (e.g., background of FIG. 2) and a second end (e.g., foreground of FIG. 2) with a rectangular cross section with orthogonal walls. As a specific example, image pipe 140 may have a square cross section with orthogonal walls which may form four external faces. Image pipe 140 may be configured to receive an input image beam (not shown) that may be injected at an angle by an image projector 126, for example. Image pipe 140 may provide four replicated output image beams 204-210 based on the injected image beam. As light from the injected image propagates along waveguide 140 while being reflected from all four external faces, four conjugate image beams (e.g., image beam vectors) may be generated 202-208 which represent the same image as it is reflected internally by the faces. Portions of or an entirety of one or more outer surfaces of image pipe 140 may be coated with partially or fully reflective coatings or a low refractive index (LRI) adhesive to promote conduction of an injected image beam and to reduce loss. Image pipe 140 may include a glass material, an acrylic material, and/or a polycarbonate material having the same or different index of refraction compared with other elements in system 100, for example. Image pipe 140 may be attached to or integrated with one or more waveguide elements and may be considered to be an imbedded image pipe, as will be described more fully below.

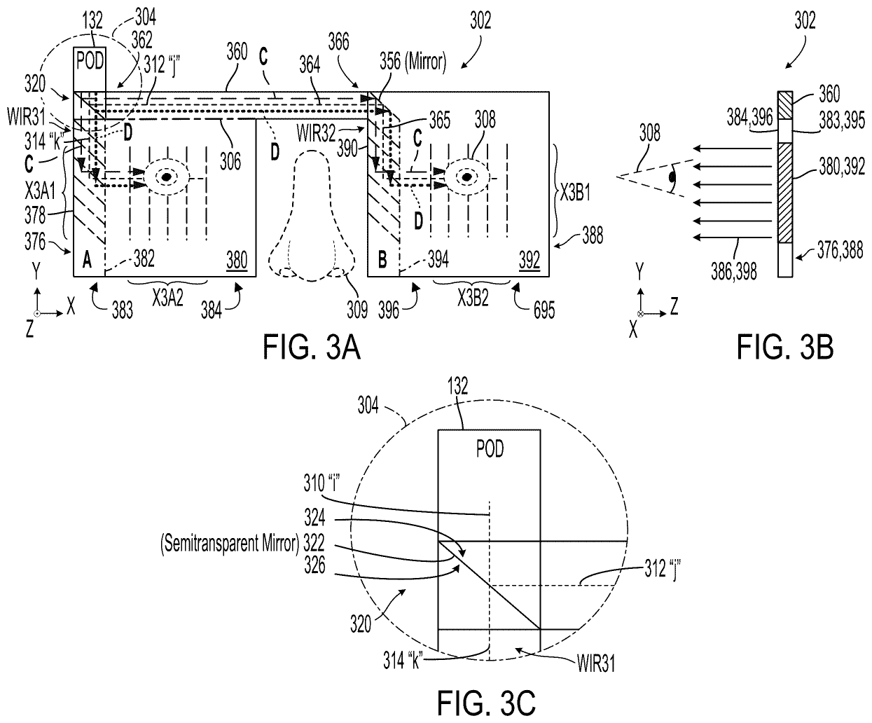

FIGS. 3A-3C illustrate details regarding an optical system, in accordance with various examples of the present disclosure. In particular, FIG. 3A illustrates a front plan view of an optical device 302, FIG. 3B illustrates a side plan view of a portion of optical device 302, and FIG. 3C illustrates an enlarged view 304 of a portion of optical device 302, in accordance with various examples of the present disclosure. In FIG. 3A and elsewhere, an eye 308 and a nose 309 of a user may be illustrated to provide a reference for how optical system 302 may be worn on a head of a user and used to provide optical information, as described.

According to an example, an optical device 302 may include a coupling assembly 320, an image pipe 360, a first waveguide 376, and a second waveguide 388. Coupling assembly 320 may be similar in some ways to coupling assembly 136 of FIG. 1. Coupling assembly 320 may be configured to receive a collimated image beam 310 (e.g., an “i” image beam) from projecting optical device 132 and provide a first output image beam 312 (e.g., a “j” image beam) and a second output image beam 314 (e.g., a “k” image beam). As used herein, the beams i, j, and k may denote projections of the beams along an image pipe where the beams may propagate at oblique angles with relation to a side of the image pipe, for example. As shown in various figures, the beams may denote the projection of the propagation direction of a collimated beam that may be associated with a single field within a field of view. In particular, coupling assembly 320 may include a passive optical element such as a cube beam splitter or a semitransparent mirror 322 having a first side 324 oriented toward projecting optical device 132, and a second side 326 that is opposite first side 324 and oriented toward a first waveguide injection region WIR31 of first waveguide 376, for example. In this manner, collimated image beam 310 may be applied to semitransparent mirror 322 first side 324 as an input beam to coupling assembly 320 which may partially reflect a portion of collimated image beam 310 to be emitted from coupling assembly 320 as first output image beam 312 and semitransparent mirror 322 may partially transmit a portion of collimated image beam 310 to be emitted from coupling assembly 320 as second output image beam 314.

Image pipe 360 may be similar in some ways to image pipe(s) 140 described in reference to FIG. 1 and FIG. 2. Image pipe 360 may be configured to receive first output image beam 312 at an image pipe input 362 (e.g., image pipe 360 first end) and provide at least one propagated image beam 364 at an image pipe output 366 (e.g., image pipe 360 second end). First waveguide 376 may have a first waveguide front surface 383 that is parallel with a first waveguide rear surface 384. First waveguide 376 may be configured to receive second output image beam 314 and emit a first expanded output image beam 386 from first waveguide rear surface 384. As described, the terms first, second, third, and the like may be assigned to designate distinct elements and associations but could be assigned differently or changed depending on a particular example. Similar in some ways to first waveguide 376, second waveguide 388 may have a second waveguide front surface 395 and a second waveguide rear surface 396. Second waveguide 388 may be configured to receive the at least one propagated image beam 364 from image pipe 360 and emit a second expanded output image beam 398 from second waveguide rear surface 396.

First waveguide 376 (labeled as “A”) may include a first waveguide first aperture expander 378 and a first waveguide second aperture expander 380 separated from each other by a first waveguide dividing region 382. First waveguide first aperture expander 378 may include a first plurality of planar, mutually-parallel and partially reflecting optical elements (e.g., facets) spaced apart from each other which may be inclined at an angle that may be one of oblique relative to at least one of first waveguide front surface 383 and a plane (e.g., an X-Z plane) that is perpendicular to first waveguide front surface 383. First waveguide first aperture expander 378 may also include embedded volume or surface optical diffractive elements. Illumination from the second output image beam 314 may be received in a first direction (e.g., along a central axis of first waveguide aperture expander 378) and then reflected in a second direction and propagated within first waveguide 376 as a first waveguide first plurality of expanded image beams X3A1 that may be directed to first waveguide second aperture expander 380. In this manner, second output image beam 314 illumination may be expanded in a first dimension by the spaced apart facets of first waveguide aperture expander 378 to provide the first plurality of expanded image beams X3A1. A reflectivity of the first plurality of partially reflecting facets in first waveguide first aperture expander 378 may increase in a direction away from waveguide injection region WIR31, where the first waveguide first aperture expander 378 may have an initial facet with a lowest reflectivity and may terminate with a final facet (e.g., a terminal facet) that may be highly reflective, and may be a fully reflective mirror. Alternatively, a reflectivity of the first plurality of partially reflecting facets may be constant in a direction away from waveguide region WIR31 and, separate from this feature, may terminate with a final facet that may or may not be a mirror. A portion of first waveguide 376 may be affixed to a portion of image pipe 360 with any of the following: a layer of low refractive index (LRI) adhesive 306, a layer of low refractive index coating, or a thin film coating that assures total (or nearly total) internal reflection (TIR). Alternatively, the first waveguide 376 may be air-spaced from image pipe 360. These alternatives may also apply to the various examples disclosed herein.

Similarly, first waveguide second aperture expander 380 may include a second plurality of planar, mutually-parallel and partially reflecting optical elements (e.g., facets) spaced apart from each other which may be inclined at an angle that may be one of oblique relative to at least one of first waveguide front surface 383 and a plane (e.g., an X-Z plane) that is perpendicular to first waveguide front surface 383. Illumination from the first plurality of expanded image beams X3A1 may be received in the second direction and then reflected in a third direction toward first waveguide rear surface 384 by the second plurality of partially reflecting optical elements in first waveguide second aperture expander 380. In this manner, illumination from first plurality of expanded image beams X3A1 may be expanded in a second dimension by the spaced apart facets of first waveguide second aperture expander 380 to provide the second plurality of expanded image beams X3A2. The plurality of expanded image beams X3A1 may be expanded in a second dimension that is different from the first dimension to provide a second plurality of expanded image beams X3A2. Thus, the first waveguide first aperture expander 378 and the first waveguide second aperture expander 380 may cooperate to provide a two-dimensional (2D) expansion of second output image beam 314 illumination as a first expanded output image beam 386 that may be emitted from first waveguide rear surface 384. Similar to first waveguide first aperture expander 378, a reflectivity of the second plurality of partially reflecting facets in first waveguide second aperture expander 380 may increase in a direction away from first waveguide first aperture expander 378, where the first waveguide second aperture expander 380 may have an initial facet with a lowest reflectivity and a final facet (e.g., a terminal facet) that may be a mirror. Alternatively, a reflectivity of the first plurality of partially reflecting facets may be constant in a direction away from first waveguide first aperture expander 378 and, separate from this feature, may terminate with a final facet that may or may not be a mirror.

Second waveguide 388 (labeled as “B”) may include a second waveguide first aperture expander 390 and a second waveguide second aperture expander 392 separated from each other by a second waveguide dividing region 394. Second waveguide 388 may also include a mirror 356 configured to receive the at least one propagated image beam 364 and provide a reflected at least one propagated image beam 365. Second waveguide first aperture expander 390 may include a third plurality of planar, mutually-parallel and partially reflecting optical elements (e.g., facets) spaced apart from each other which may be inclined at an angle that may be one of oblique relative to at least one of second waveguide front surface 395 and a plane (e.g., an X-Z plane) that is perpendicular to second waveguide front surface 395. Second waveguide first aperture expander 390 may also include an embedded volume or surface optical diffractive elements. Illumination from the reflected at least one propagated image beam 365 may be received in a fourth direction (e.g., along a central axis of the second waveguide aperture expander 390) and then reflected in a fifth direction by the first plurality of partially reflecting optical elements in second waveguide first aperture expander 390 and conducted within second waveguide 388 as a second waveguide first plurality of expanded image beams X3B1 that may be directed to second waveguide second aperture expander 392. In this manner, the reflected at least one propagated image beam 365 illumination may be expanded in a first dimension (e.g., a third dimension) by the spaced apart facets to provide the first plurality of expanded image beams X3B1. A reflectivity of the third plurality of partially reflecting facets in second waveguide first aperture expander 390 may increase in a direction away from a second waveguide injection region WIR32, where the second waveguide first aperture expander 390 may have an initial facet with a lowest reflectivity and may terminate with a final facet (e.g., a terminal facet) that may highly reflective, or may be a mirror. Alternatively, a reflectivity of the third plurality of partially reflecting facets may be constant in a direction away from waveguide region WIR32 and, separate from this feature, may terminate with a final facet that may or may not be a mirror.

Similarly, second waveguide second aperture expander 392 may include a fourth plurality of planar, mutually-parallel and partially reflecting optical elements (e.g., facets) spaced apart from each other which may be inclined at an angle that may be one of oblique relative to at least one of second waveguide front surface 395 and a plane (e.g., an X-Z plane) that is perpendicular to second waveguide front surface 395. Second waveguide second aperture expander 392 may also include embedded volume or surface optical diffractive elements. Illumination from the third plurality of expanded image beams X3B1 may be received in the fifth direction and then reflected in a sixth direction toward second waveguide rear surface 396 by the fourth plurality of partially reflecting optical elements in second waveguide second aperture expander 392. In this manner, illumination from third plurality of expanded image beams X3B1 may be expanded in a second dimension (e.g., a fourth dimension) by the spaced apart facets of second waveguide second aperture expander 392 to provide the second plurality of expanded image beams X3B2. The plurality of expanded image beams X3B1 may be expanded in a second dimension that is different from the first dimension to provide a second plurality of expanded image beams X3B2. Thus, the second waveguide first aperture expander 390 and the second waveguide second aperture expander 392 may cooperate to provide a two-dimensional (2D) expansion of the reflected at least one propagated image beam 365 illumination as a second expanded output image beam 398 that may be emitted from second waveguide rear surface 396. Similar to second waveguide first aperture expander 390, a reflectivity of the fourth plurality of partially reflecting facets in second waveguide second aperture expander 392 may increase in a direction away from second waveguide first aperture expander 390, where the second waveguide second aperture expander 392 may have an initial facet with a lowest reflectivity and a final facet (e.g., a terminal facet) that may be highly reflective and may be a mirror. Alternatively, a reflectivity of the fourth plurality of partially reflecting facets may be constant in a direction away from second waveguide first aperture expander 390 and, separate from this feature, may terminate with a final facet that may or may not be a mirror.

As described above, image projector 132 may provide a collimated image beam 310 (e.g., a collimated single field) that may be an illuminated representation of the digital image having an image field which is a two-dimensional representation of the digital image. In this manner, the image field may have a vertical and/or lateral extent, as illustrated in FIG. 3A, and elsewhere. For example, first output image beam 312 may propagate through image pipe 360 and into second waveguide 388 having a vertical extent (labeled as “C” and “D”), reflected by mirror 356, and then reflected by second waveguide first aperture expander 390. In this manner, a single pixel on the image may correspond with a collimated beam and a single beam. Accordingly, beams C and D may be laterally displaced beams with the same orientation (e.g., the lines are parallel), and therefore they may be associated with the same field, for example. The extension of beams described herein may not relate to an extension of an output image that may be observed by a user. Similarly, second output image beam 314 may propagate into first waveguide 376 having a lateral extent (labeled as “C” and “D”) and reflected by first waveguide first aperture expander 378. Thus, first output image beam 312 and second output image beam 314 and others may propagate through various optical elements in optical system 100 as a two-dimensional (2D) image field about the illustrated central axes. In some examples, mirror 356 may not be used.

According to an example, first waveguide first aperture expander 378 and second waveguide first aperture expander 390 may be oriented parallel to each other. Further, second waveguide first aperture expander 390 may be disposed on a side of second waveguide 388 that is closest to (e.g., proximal to) first waveguide 376, as shown in FIG. 3A. Other arrangements are also possible, where second waveguide first aperture expander 390 may be disposed on a side of second waveguide 388 that is farthest from (e.g., distal from) first waveguide 376. As mentioned briefly above, beams drawn in the various figures may denote the projection of the propagation direction of a collimated beam that is associated with a single field within the field of view (FoV). In a practical system, within the first or second waveguide these beams may be ascending and descending beams that may be trapped in the waveguides by total internal reflection (TIR). Within an image pipe, the beams may be ascending right, ascending left, descending right and descending left.

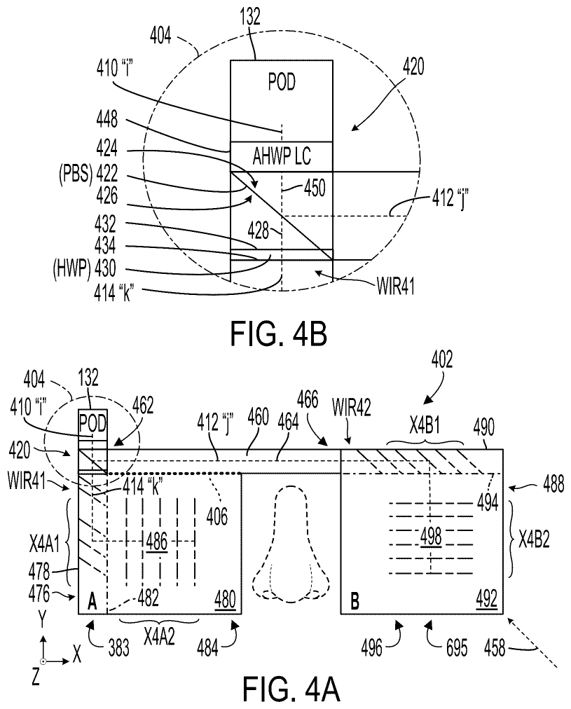

FIGS. 4A-4B illustrate details regarding an optical system, in accordance with various examples of the present disclosure. In particular, FIG. 4A illustrates a front plan view of an optical device 402, and FIG. 4B illustrates an enlarged view 404 of a portion of optical device 402, in accordance with various examples of the present disclosure.

According to an example, an optical device 402 may include a coupling assembly 420, an image pipe 460, a first waveguide 476, and a second waveguide 488. Coupling assembly 420 may be similar in some ways to coupling assembly 136 of FIG. 1. Coupling assembly 420 may be configured to receive a collimated image beam 410 (e.g., an “i” image beam) from projecting optical device 132 and provide a first output image beam 412 (e.g., a “j” image beam) and a second output image beam 414 (e.g., a “k” image beam). In particular, coupling assembly 420 may include a passive optical element such as a polarizing beam splitter (PBS) 422 having a first side 424 oriented toward projecting optical device 132, and a second side 426 that is opposite first side 424 and oriented toward a first waveguide injection region WIR41 of first waveguide 476, for example. In this manner, collimated image beam 410 may be applied to polarizing beam splitter 422 first side 424 as an input beam to coupling assembly 420 which may partially reflect a portion of collimated image beam 410 to be emitted from coupling assembly 420 as first output image beam 412 and polarizing beam splitter 422 may partially transmit a portion of collimated image beam 410 to be emitted from polarizing beam splitter 424 second side 426 as transmitted image beam 428.

Collimated image beam 410 may include polarized illumination. Polarizing beam splitter 422 may include a wire grid, crystal, directional polymer, or dielectric material that reflects S polarization (e.g., perpendicular) but transmits P polarization (e.g., parallel), or vice versa. Hence, polarizing beam splitter may receive collimated image beam 410 and provide first output beam 412 as an S-polarized image beam and transmitted image beam 428 as a P-polarized image beam. Coupling assembly 420 may also include a half wave plate (HWP) 430 having a half wave plate first side 432 and a half wave plate second side 434. Half wave plate 430 may include a crystal or dielectric material configured to retard (e.g., delay) one component of polarization to transmit light and modify polarization without attenuating, deviating, or displacing the incident beam. Thus, half wave plate 430 first side 432 may receive transmitted beam 428 and provide second output image beam 414 from half wave plate 430 second side 434. In this example, transmitted beam 428 is P-polarized by passing through polarizing beam splitter 422, and second output image beam 414 is converted to S-polarization by passing through half wave plate 430 so that both first output beam 412 and second output beam 414 have the same S-polarization.

Image pipe 460 may be similar in some ways to image pipe(s) 140 described in reference to FIG. 1 and FIG. 2. Image pipe 460 may be configured to receive first output image beam 412 at an image pipe input 462 (e.g., image pipe 460 first end) and provide at least one propagated image beam 464 at an image pipe output 466 (e.g., image pipe 460 second end). First waveguide 476 may have a first waveguide front surface 483 that is parallel with a first waveguide rear surface 484. First waveguide 476 may be configured to receive second output image beam 414 and emit a first expanded output image beam 486 from first waveguide rear surface 484. Similar in some ways to first waveguide 476, second waveguide 488 may have a second waveguide front surface 495 and a second waveguide rear surface 496. Second waveguide 488 may be configured to receive the at least one propagated image beam 464 from image pipe 460 and emit a second expanded output image beam 498 from second waveguide rear surface 396.

First waveguide 476 (labeled as “A”) may include a first waveguide first aperture expander 478 and a first waveguide second aperture expander 480 separated from each other by a first waveguide dividing region 482. First waveguide first aperture expander 478 may include a first plurality of planar, mutually-parallel and partially reflecting optical elements (e.g., facets) spaced apart from each other which may be inclined at an angle that may be one of oblique relative to at least one of first waveguide front surface 483 and a plane (e.g., an X-Z plane) that is perpendicular to first waveguide front surface 483. Illumination from the second output image beam 414 may be received in a first direction (e.g., along a central axis of first waveguide aperture expander 478) and then reflected in a second direction and propagated within first waveguide 476 as a first waveguide first plurality of expanded image beams X4A1 that may be directed to first waveguide second aperture expander 480. In this manner, second output image beam 414 illumination may be expanded in a first dimension by the spaced apart facets of first waveguide aperture expander 478 to provide the first plurality of expanded image beams X4A1. A reflectivity of the first plurality of partially reflecting facets in first waveguide first aperture expander 478 may increase in a direction away from waveguide injection region WIR41, where the first waveguide first aperture expander 478 may have an initial facet with a lowest reflectivity and may terminate with a final facet that may be a fully reflective mirror. Alternatively, a reflectivity of the first plurality of partially reflecting facets may be constant in a direction away from waveguide region WIR41 and, separate from this feature, may terminate with a final facet that may or may not be a mirror. A portion of first waveguide 476 may be affixed to a portion of image pipe 460 with a layer of low refractive index (LRI) adhesive 406.

Similarly, first waveguide second aperture expander 480 may include a second plurality of planar, mutually-parallel and partially reflecting optical elements (e.g., facets) spaced apart from each other which may be inclined at an angle that may be one of oblique relative to at least one of first waveguide front surface 483 and a plane (e.g., an X-Z plane) that is perpendicular to first waveguide front surface 483. Illumination from the first plurality of expanded image beams X4A1 may be received in the second direction and then reflected in a third direction toward first waveguide rear surface 484 by the second plurality of partially reflecting optical elements in first waveguide second aperture expander 480. In this manner, illumination from first plurality of expanded image beams X4A1 may be expanded in a second dimension by the spaced apart facets of first waveguide second aperture expander 480 to provide the second plurality of expanded image beams X4A2. The plurality of expanded image beams X4A1 may be expanded in a second dimension that is different from the first dimension to provide a second plurality of expanded image beams X4A2. Thus, the first waveguide first aperture expander 478 and the first waveguide second aperture expander 480 may cooperate to provide a two-dimensional (2D) expansion of second output image beam 414 illumination as a first expanded output image beam 486 that may be emitted from first waveguide rear surface 484. Similar to first waveguide first aperture expander 478, a reflectivity of the second plurality of partially reflecting facets in first waveguide second aperture expander 480 may increase in a direction away from first waveguide first aperture expander 478, where the first waveguide second aperture expander 480 may have an initial facet with a lowest reflectivity and a final facet that may be a mirror. Alternatively, a reflectivity of the first plurality of partially reflecting facets may be constant in a direction away from first waveguide first aperture expander 478 and, separate from this feature, may terminate with a final facet that may or may not be a mirror.

Second waveguide 488 (labeled as “B”) may include a second waveguide first aperture expander 490 and a second waveguide second aperture expander 492 separated from each other by a second waveguide dividing region 494. Second waveguide first aperture expander 490 may include a third plurality of planar, mutually-parallel and partially reflecting optical elements (e.g., facets) spaced apart from each other which may be inclined at an angle that may be one of oblique relative to at least one of second waveguide front surface 495 and a plane (e.g., an X-Z plane) that is perpendicular to second waveguide front surface 495. Illumination from the at least one propagated image beam 464 may be received in a fourth direction (e.g., along a central axis of the second waveguide aperture expander 490) and then reflected in a fifth direction by the first plurality of partially reflecting optical elements in second waveguide first aperture expander 490 and conducted within second waveguide 488 as a second waveguide first plurality of expanded image beams X4B1 that may be directed to second waveguide second aperture expander 492. In this manner, the at least one propagated image beam 464 illumination may be expanded in a first dimension (e.g., a third dimension) by the spaced apart facets to provide the first plurality of expanded image beams X4B1. A reflectivity of the third plurality of partially reflecting facets in second waveguide first aperture expander 490 may increase in a direction away from a second waveguide injection region WIR42, where the second waveguide first aperture expander 490 may have an initial facet with a lowest reflectivity and may terminate with a final facet that may be a mirror. Alternatively, a reflectivity of the third plurality of partially reflecting facets may be constant in a direction away from waveguide region WIR42 and, separate from this feature, may terminate with a final facet that may or may not be a mirror.

Similarly, second waveguide second aperture expander 492 may include a fourth plurality of planar, mutually-parallel and partially reflecting optical elements (e.g., facets) spaced apart from each other which may be inclined at an angle that may be one of oblique relative to at least one of second waveguide front surface 495 and a plane (e.g., an X-Z plane) that is perpendicular to second waveguide front surface 495. Illumination from the third plurality of expanded image beams X4B1 may be received in the fifth direction and then reflected in a sixth direction toward second waveguide rear surface 496 by the fourth plurality of partially reflecting optical elements in second waveguide second aperture expander 492. In this manner, illumination from third plurality of expanded image beams X4B1 may be expanded in a second dimension (e.g., a fourth dimension) by the spaced apart facets of second waveguide second aperture expander 492 to provide the second plurality of expanded image beams X4B2. In this manner, the plurality of expanded image beams X4B1 may be expanded in a second dimension that is different from the first dimension to provide a second plurality of expanded image beams X4B2. Thus, the second waveguide first aperture expander 490 and the second waveguide second aperture expander 492 may cooperate to provide a two-dimensional (2D) expansion of the reflected at least one propagated image beam 464 illumination as a second expanded output image beam 498 that may be emitted from second waveguide rear surface 496. Similar to second waveguide first aperture expander 490, a reflectivity of the fourth plurality of partially reflecting facets in second waveguide second aperture expander 492 may increase in a direction away from second waveguide first aperture expander 490, where the second waveguide second aperture expander 492 may have an initial facet with a lowest reflectivity and a final facet (e.g., a terminal facet) that is a mirror. Alternatively, a reflectivity of the fourth plurality of partially reflecting facets may be constant in a direction away from second waveguide first aperture expander 490 and, separate from this feature, may terminate with a final facet that may or may not be a mirror.

As described above, image projector 132 may provide a collimated image beam 410 that may be an illuminated representation of the digital image having an image field which is a two-dimensional representation of the digital image. Thus, first output image beam 412 and second output image beam 414 and others may propagate through various optical elements in optical system 100 as a two-dimensional (2D) image field about the illustrated central axes.

According to an example, first waveguide first aperture expander 478 and second waveguide first aperture expander 490 may be oriented perpendicular to each other. Other arrangements are also possible, where second waveguide first aperture expander 490 may be disposed on a side of second waveguide 488 that is farthest from (e.g., distal from) first waveguide 476. In this case, second waveguide 488 and various components may be oppositely arranged (e.g., reflected, flipped, or rotated) about a diagonal axis 458 where second input aperture 490 may be arranged vertically above or below diagonal axis 458 as compared with FIG. 3A, for example.

According to an example, coupling assembly 420 may also include an active half wave plate liquid crystal element (AHWP) 448 configured to receive the collimated image beam 410 and provide a transformed image beam 450. Active half wave plate liquid crystal element 448 may be an active optical element controlled by signals from controller 114 to selectively change polarity of at least a portion of collimated image beam 410 and provide transformed image beam 450, such as changing from an S-polarization to a P-polarization when activated, for example. In this example, polarizing beam splitter 422 first side 424 may receive transformed image beam 450 and provide first output image beam 412 from polarizing beam splitter 422 first side 424 and provide transmitted beam 428 from polarizing beam splitter second side 426. In this manner, optical device 402 may be practiced with or without active half wave plate liquid crystal element 448.

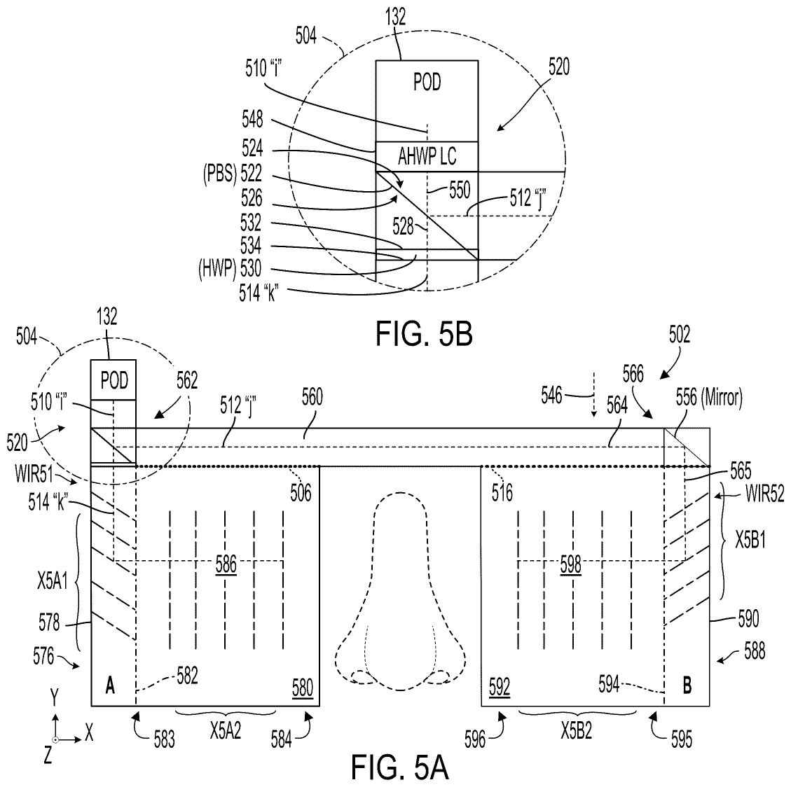

FIGS. 5A-5B illustrate details regarding an optical system, in accordance with various examples of the present disclosure. In particular, FIG. 5A illustrates a front plan view of an optical device 502, and FIG. 5B illustrates an enlarged view 504 of a portion of optical device 502, in accordance with various examples of the present disclosure.

According to an example, an optical device 502 may include a coupling assembly 520, an image pipe 560, a first waveguide 576, and a second waveguide 588. Coupling assembly 520 may be similar in some ways to coupling assembly 136 of FIG. 1. As mentioned above, like reference numbers and like element names may indicate identical or functionally similar elements. For example, coupling assembly 520 may be similar in some ways to coupling assembly 320 described in reference to FIG. 3A, and coupling assembly 520 may be similar in some ways to coupling assembly 420 described in reference to FIG. 4A, for example. Coupling assembly 520 may be configured to receive a collimated image beam 510 (e.g., an “i” image beam) from projecting optical device 132 and provide a first output image beam 512 (e.g., a “j” image beam) and a second output image beam 514 (e.g., a “k” image beam). In particular, coupling assembly 520 may include a passive optical element such as a polarizing beam splitter (PBS) 522 having a first side 524 oriented toward projecting optical device 132, and a second side 526 that is opposite first side 524 and oriented toward a first waveguide injection region WIR51 of first waveguide 576, for example. In this manner, collimated image beam 510 may be applied to polarizing beam splitter 522 first side 524 as an input beam to coupling assembly 520 which may partially reflect a portion of collimated image beam 510 to be emitted from coupling assembly 520 as first output image beam 512 and polarizing beam splitter 522 may partially transmit a portion of collimated image beam 510 to be emitted from polarizing beam splitter 524 second side 526 as transmitted image beam 528. Collimated image beam 510 may include polarized illumination. Polarizing beam splitter 522 may include a wire grid, crystal, or dielectric material that reflects S polarization (e.g., perpendicular) but transmits P polarization (e.g., parallel). Hence, polarizing beam splitter may receive collimated image beam 510 and provide first output beam 512 as an S-polarized image beam and transmitted image beam 528 as a P-polarized image beam. Coupling assembly 520 may also include a half wave plate (HWP) 530 having a half wave plate first side 532 and a half wave plate second side 534. Half wave plate 530 may include a crystal or dielectric material configured to retard (e.g., delay) one component of polarization to transmit light and modify polarization without attenuating, deviating, or displacing the incident beam. Thus, half wave plate 530 first side 532 may receive transmitted beam 528 and provide second output image beam 514 from half wave plate 530 second side 534. In this example, transmitted beam 528 is P-polarized by passing through polarizing beam splitter 522, and second output image beam 514 is converted to S-polarization by passing through half wave plate 530 so that both first output beam 512 and second output beam 514 have the same S-polarization.

Image pipe 560 may be similar in some ways to image pipe(s) 140 described in reference to FIG. 1 and FIG. 2. Image pipe 560 may be configured to receive first output image beam 512 at an image pipe input 562 (e.g., image pipe 560 first end) and provide at least one propagated image beam 564 at an image pipe output 566 (e.g., image pipe 560 second end). First waveguide 576 may have a first waveguide front surface 583 that is parallel with a first waveguide rear surface 584. First waveguide 576 may be configured to receive second output image beam 514 and emit a first expanded output image beam 586 from first waveguide rear surface 584. Similar in some ways to first waveguide 576, second waveguide 588 may have a second waveguide front surface 595 and a second waveguide rear surface 596. Second waveguide 588 may be configured to receive the at least one propagated image beam 564 from image pipe 560 and emit a second expanded output image beam 598 from second waveguide rear surface 396.

First waveguide 576 (labeled as “A”) may include a first waveguide first aperture expander 578 and a first waveguide second aperture expander 580 separated from each other by a first waveguide dividing region 582. First waveguide first aperture expander 578 may include a first plurality of planar, mutually-parallel and partially reflecting optical elements (e.g., facets) spaced apart from each other which may be inclined at an angle that may be one of oblique relative to at least one of first waveguide front surface 583 and a plane (e.g., an X-Z plane) that is perpendicular to first waveguide front surface 583. Illumination from the second output image beam 514 may be received in a first direction (e.g., along a central axis of first waveguide aperture expander 578) and then reflected in a second direction and propagated within first waveguide 576 as a first waveguide first plurality of expanded image beams X5A1 that may be directed to first waveguide second aperture expander 580. In this manner, second output image beam 514 illumination may be expanded in a first dimension by the spaced apart facets of first waveguide aperture expander 578 to provide the first plurality of expanded image beams X5A1. A reflectivity of the first plurality of partially reflecting facets in first waveguide first aperture expander 578 may increase in a direction away from waveguide injection region WIR51, where the first waveguide first aperture expander 578 may have an initial facet with a lowest reflectivity and may terminate with a final facet that may be a fully reflective mirror. Alternatively, a reflectivity of the first plurality of partially reflecting facets may be constant in a direction away from waveguide region WIR51 and, separate from this feature, may terminate with a final facet that may or may not be a mirror. A portion of first waveguide 576 may be affixed to a portion of image pipe 560 with a layer of low refractive index (LRI) adhesive 506.

Similarly, first waveguide second aperture expander 580 may include a second plurality of planar, mutually-parallel and partially reflecting optical elements (e.g., facets) spaced apart from each other which may be inclined at an angle that may be one of oblique relative to at least one of first waveguide front surface 583 and a plane (e.g., an X-Z plane) that is perpendicular to first waveguide front surface 583. Illumination from the first plurality of expanded image beams X5A1 may be received in the second direction and then reflected in a third direction toward first waveguide rear surface 584 by the second plurality of partially reflecting optical elements in first waveguide second aperture expander 580. In this manner, illumination from first plurality of expanded image beams X5A1 may be expanded in a second dimension by the spaced apart facets of first waveguide second aperture expander 580 to provide the second plurality of expanded image beams X5A2. The plurality of expanded image beams X5A1 may be expanded in a second dimension that is different from the first dimension to provide a second plurality of expanded image beams X5A2. Thus, the first waveguide first aperture expander 578 and the first waveguide second aperture expander 580 may cooperate to provide a two-dimensional (2D) expansion of second output image beam 514 illumination as a first expanded output image beam 586 that may be emitted from first waveguide rear surface 584. Similar to first waveguide first aperture expander 578, a reflectivity of the second plurality of partially reflecting facets in first waveguide second aperture expander 580 may increase in a direction away from first waveguide first aperture expander 578, where the first waveguide second aperture expander 580 may have an initial facet with a lowest reflectivity and a final facet that may be a mirror. Alternatively, a reflectivity of the first plurality of partially reflecting facets may be constant in a direction away from first waveguide first aperture expander 578 and, separate from this feature, may terminate with a final facet that may or may not be a mirror.

Second waveguide 588 (labeled as “B”) may include a second waveguide first aperture expander 590 and a second waveguide second aperture expander 592 separated from each other by a second waveguide dividing region 594. Second waveguide 588 may also include a mirror 556 configured to receive the at least one propagated image beam 564 and provide a reflected at least one propagated image beam 565. Second waveguide first aperture expander 590 may include a third plurality of planar, mutually-parallel and partially reflecting optical elements (e.g., facets) spaced apart from each other which may be inclined at an angle that may be one of oblique relative to at least one of second waveguide front surface 595 and a plane (e.g., an X-Z plane) that is perpendicular to second waveguide front surface 595. Illumination from the reflected at least one propagated image beam 565 may be received in a fourth direction (e.g., along a central axis of the second waveguide aperture expander 590) and then reflected in a fifth direction by the first plurality of partially reflecting optical elements in second waveguide first aperture expander 590 and conducted within second waveguide 588 as a second waveguide first plurality of expanded image beams X5B1 that may be directed to second waveguide second aperture expander 592. In this manner, the reflected at least one propagated image beam 565 illumination may be expanded in a first dimension (e.g., a third dimension) by the spaced apart facets to provide the first plurality of expanded image beams X5B1. A reflectivity of the third plurality of partially reflecting facets in second waveguide first aperture expander 590 may increase in a direction away from a second waveguide injection region WIR52, where the second waveguide first aperture expander 590 may have an initial facet with a lowest reflectivity and may terminate with a final facet that may be a mirror. Alternatively, a reflectivity of the third plurality of partially reflecting facets may be constant in a direction away from waveguide region WIR52 and, separate from this feature, may terminate with a final facet that may or may not be a mirror.

Similarly, second waveguide second aperture expander 592 may include a fourth plurality of planar, mutually-parallel and partially reflecting optical elements (e.g., facets) spaced apart from each other which may be inclined at an angle that may be one of oblique relative to at least one of second waveguide front surface 595 and a plane (e.g., an X-Z plane) that is perpendicular to second waveguide front surface 595. Illumination from the third plurality of expanded image beams X5B1 may be received in the fifth direction and then reflected in a sixth direction toward second waveguide rear surface 596 by the fourth plurality of partially reflecting optical elements in second waveguide second aperture expander 592. In this manner, illumination from third plurality of expanded image beams X5B1 may be expanded in a second dimension (e.g., a fourth dimension) by the spaced apart facets of second waveguide second aperture expander 592 to provide the second plurality of expanded image beams X5B2. In this manner, the plurality of expanded image beams X5B1 may be expanded in a second dimension that is different from the first dimension to provide a second plurality of expanded image beams X5B2. Thus, the second waveguide first aperture expander 590 and the second waveguide second aperture expander 592 may cooperate to provide a two-dimensional (2D) expansion of the reflected at least one propagated image beam 565 illumination as a second expanded output image beam 598 that may be emitted from second waveguide rear surface 596. Similar to second waveguide first aperture expander 590, a reflectivity of the fourth plurality of partially reflecting facets in second waveguide second aperture expander 592 may increase in a direction away from second waveguide first aperture expander 590, where the second waveguide second aperture expander 592 may have an initial facet with a lowest reflectivity and a final facet (e.g., a terminal facet) that is a mirror. Alternatively, a reflectivity of the fourth plurality of partially reflecting facets may be constant in a direction away from second waveguide first aperture expander 590 and, separate from this feature, may terminate with a final facet that may or may not be a mirror. As described above, image projector 132 may provide a collimated image beam 510 that may be an illuminated representation of the digital image having an image field which is a two-dimensional representation of the digital image. Thus, first output image beam 512 and second output image beam 514 and others may propagate through various optical elements in optical system 100 as a two-dimensional (2D) image field about the illustrated central axes. A portion of second waveguide 588 may be affixed to a portion of image pipe 560 with a layer of low refractive index (LRI) adhesive 516.

According to an example, first waveguide first aperture expander 578 and second waveguide first aperture expander 590 may be oriented parallel to each other. Other arrangements are also possible, where second waveguide first aperture expander 590 may be disposed on a side of second waveguide 588 that is farthest from (e.g., distal from) first waveguide 576. In this case, second waveguide 588 may be oppositely arranged about a vertical axis 546 where second input aperture 590 may be arranged horizontally left or right of second waveguide second aperture 592 as compared with FIG. 3A, for example.

According to an example, coupling assembly 520 may also include an active half wave plate liquid crystal element (AHWP) 548 configured to receive the collimated image beam 510 and provide a transformed image beam 550. Active half wave plate liquid crystal element 548 may be an active optical element controlled by signals from controller 114 to selectively change polarity of at least a portion of collimated image beam 510 and provide transformed image beam 550, such as changing from an S-polarization to a P-polarization when activated, for example. In this example, polarizing beam splitter 522 first side 524 may receive transformed image beam 550 and provide first output image beam 512 from polarizing beam splitter 522 first side 524 and provide transmitted beam 528 from polarizing beam splitter second side 526. In this manner, optical device 502 may be practiced with or without active half wave plate liquid crystal element 548. Coupling assemblies 420 and 520 may include various active or passive optical elements as described. In the system illustrated in FIG. 4 and FIG. 5, an image may be rotated between the first waveguide and the second waveguide. In a practical system, in order to avoid introduction of a possibly 50% flipped, ghost image, the image provided by the image projector may be rotated.

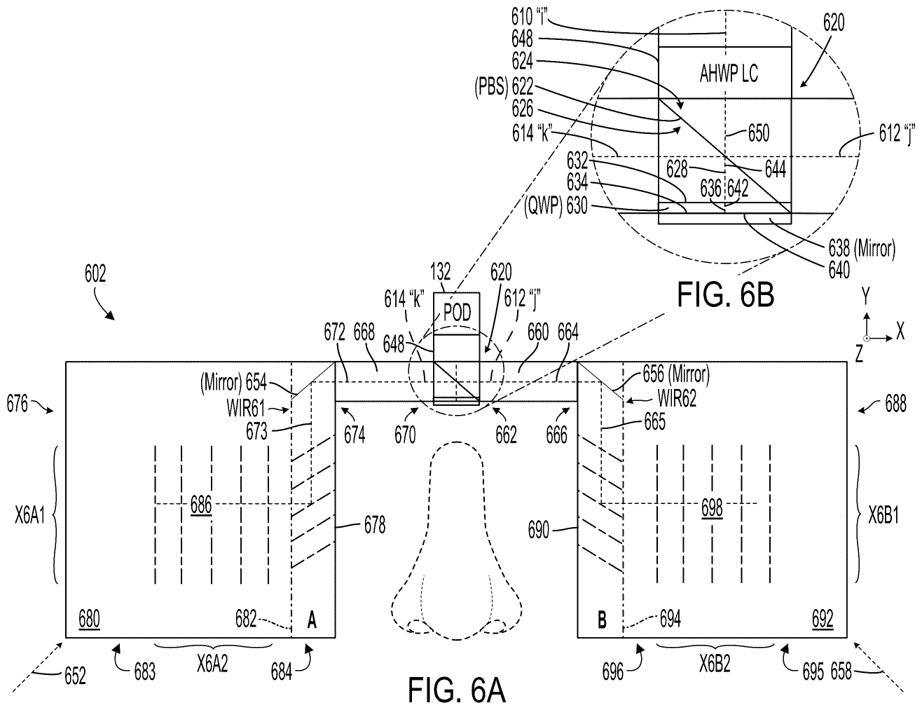

FIGS. 6A-6B illustrate details regarding an optical system, in accordance with various examples of the present disclosure. In particular, FIG. 6A illustrates a front plan view of an optical device 602, and FIG. 6B illustrates an enlarged view 604 of a portion of optical device 602, in accordance with various examples of the present disclosure.

According to an example, an optical device 602 may include a coupling assembly 620, a first image pipe 660, a second image pipe 668, a first waveguide 676, and a second waveguide 688. Coupling assembly 620 may be similar in some ways to coupling assembly 136 of FIG. 1. Coupling assembly 620 may be configured to receive a collimated image beam 610 (e.g., an “i” image beam) from projecting optical device 132 and provide a first output image beam 612 (e.g., a “j” image beam) and a second output image beam 614 (e.g., a “k” image beam). Collimated image beam 610 may include polarized illumination. In particular, coupling assembly 620 may include a passive optical element such as a polarizing beam splitter (PBS) 622 having a first side 624 oriented toward projecting optical device 132, and a second side 626 that is opposite first side 624 and oriented on a side away from projecting optical device 132, for example. In this manner, collimated image beam 610 may be applied to polarizing beam splitter 622 first side 624 as an input beam to coupling assembly 620 which may partially reflect a portion of collimated image beam 610 to be emitted from coupling assembly 620 as first output image beam 612 having S-polarization, and polarizing beam splitter 622 may partially transmit a portion of collimated image beam 610 to be emitted from polarizing beam splitter 624 second side 626 having P-polarization as transmitted image beam 628. Polarizing beam splitter 622 may include a wire grid, crystal, directional polymer, or dielectric material that reflects S polarization (e.g., perpendicular) but transmits P polarization (e.g., parallel). Hence, polarizing beam splitter may receive collimated image beam 610 and provide first output beam 612 as an S-polarized image beam and transmitted image beam 628 as a P-polarized image beam. Coupling assembly 620 may also include a quarter wave plate (QWP) 630 having a quarter wave plate first side 632 and a quarter wave plate second side 634. Quarter wave plate 630 may include a crystal or dielectric material configured to convert linearly polarized light into circularly polarized light and convert circularly polarized light into linearly polarized light (e.g., S-polarization or P-polarization). Thus, quarter wave plate 630 first side 632 may receive transmitted beam 628 at quarter wave plate 630 first side 632 and provide a first converted image beam 636 at quarter wave plate 630 second side 634. Coupling assembly 630 may also include a mirror 638 having a fully reflective surface 640 that is disposed adjacent to quarter wave plate second side 634 and configured to receive and reflect first converted beam 636 as a reflected image beam 642. Quarter wave plate 630 may receive reflected image beam 642 at quarter wave plate 630 second side 634 and provide a second converted image beam 644 to be emitted from quarter wave plate 630 first side 632. Polarizing beam splitter 622 second side 626 may receive second converted image beam 644 and provide a reflected second output beam 614 having S-polarization. In this manner, the first output beam 612 and the second output beam 614 may have the same S-polarization. One technical benefit provided by the sequence of transformations described above is that they support a passive system (e.g., a system with passive elements) and a symmetrical structure which may facilitate simpler design of an eye box location in relation to a nose of a user, for example.

First image pipe 660 and second image pipe 668 may be similar in some ways to image pipe(s) 140 described in reference to FIG. 1 and FIG. 2. First image pipe 660 may be configured to receive first output image beam 612 at an image pipe input 662 (e.g., first image pipe 660 first end) and provide at least one first propagated image beam 664 at a first image pipe output 666 (e.g., first image pipe 660 second end). Second image pipe 668 may be configured to receive second output image beam 614 at a second image pipe input 670 (e.g., second image pipe 668 first end) and provide at least one second propagated image beam 672 at a second image pipe output 674 (e.g., second image pipe 668 second end). In this manner, coupling assembly 620 may be considered to be integrated or embedded with the first image pipe 660 and second image pipe 668.

First waveguide 676 may have a first waveguide front surface 683 that is parallel with a first waveguide rear surface 684. First waveguide 676 may also include a first mirror 654 configured to receive the at least one second propagated image beam 672 and provide a reflected at least one second propagated image beam 673 at a first waveguide injection region WIR61. First waveguide 676 may be configured to receive the reflected at least one second propagated image beam 673 and emit a first expanded output image beam 686 from first waveguide rear surface 684. Similar in some ways to first waveguide 676, second waveguide 688 may have a second waveguide front surface 695 and a second waveguide rear surface 696. Second waveguide 688 may also include a second mirror 656 configured to receive the at least one first propagated image beam 664 and provide a reflected at least one first propagated image beam 665 at a second waveguide injection region WIR62. Second waveguide 688 may be configured to receive the reflected at least one first propagated image beam 665 and emit a second expanded output image beam 698 from second waveguide rear surface 396.

First waveguide 676 (labeled as “A”) may include a first waveguide first aperture expander 678 and a first waveguide second aperture expander 680 separated from each other by a first waveguide dividing region 682. First waveguide first aperture expander 678 may include a first plurality of planar, mutually-parallel and partially reflecting optical elements (e.g., facets) spaced apart from each other which may be inclined at an angle that may be one of oblique relative to at least one of first waveguide front surface 683 and a plane (e.g., an X-Z plane) that is perpendicular to first waveguide front surface 683. Illumination from the reflected at least one second propagated image beam 673 may be received in a first direction (e.g., along a central axis of first waveguide aperture expander 678) and then reflected in a second direction and propagated within first waveguide 676 as a first waveguide first plurality of expanded image beams X6A1 that may be directed to first waveguide second aperture expander 680. In this manner, the reflected at least one second propagated image beam 673 illumination may be expanded in a first dimension by the spaced apart facets of first waveguide aperture expander 678 to provide the first plurality of expanded image beams X6A1. A reflectivity of the first plurality of partially reflecting facets in first waveguide first aperture expander 678 may increase in a direction away from waveguide injection region WIR61, where the first waveguide first aperture expander 678 may have an initial facet with a lowest reflectivity and may terminate with a final facet that may be a fully reflective mirror. Alternatively, a reflectivity of the first plurality of partially reflecting facets may be constant in a direction away from waveguide region WIR61 and, separate from this feature, may terminate with a final facet that may or may not be a mirror.

Similarly, first waveguide second aperture expander 680 may include a second plurality of planar, mutually-parallel and partially reflecting optical elements (e.g., facets) spaced apart from each other which may be inclined at an angle that may be one of oblique relative to at least one of first waveguide front surface 683 and a plane (e.g., an X-Z plane) that is perpendicular to first waveguide front surface 683. Illumination from the first plurality of expanded image beams X6A1 may be received in the second direction and then reflected in a third direction toward first waveguide rear surface 684 by the second plurality of partially reflecting optical elements in first waveguide second aperture expander 680. In this manner, illumination from first plurality of expanded image beams X6A1 may be expanded in a second dimension by the spaced apart facets of first waveguide second aperture expander 680 to provide the second plurality of expanded image beams X6A2. The plurality of expanded image beams X6A1 may be expanded in a second dimension that is different from the first dimension to provide a second plurality of expanded image beams X6A2. Thus, the first waveguide first aperture expander 678 and the first waveguide second aperture expander 680 may cooperate to provide a two-dimensional (2D) expansion of the reflected at least one second propagated image beam 673 illumination as a first expanded output image beam 686 that may be emitted from first waveguide rear surface 684. Similar to first waveguide first aperture expander 678, a reflectivity of the second plurality of partially reflecting facets in first waveguide second aperture expander 680 may increase in a direction away from first waveguide first aperture expander 678, where the first waveguide second aperture expander 680 may have an initial facet with a lowest reflectivity and a final facet that may be a mirror. Alternatively, a reflectivity of the first plurality of partially reflecting facets may be constant in a direction away from first waveguide first aperture expander 678 and, separate from this feature, may terminate with a final facet that may or may not be a mirror.

Second waveguide 688 (labeled as “B”) may include a second waveguide first aperture expander 690 and a second waveguide second aperture expander 692 separated from each other by a second waveguide dividing region 694. Second waveguide first aperture expander 690 may include a third plurality of planar, mutually-parallel and partially reflecting optical elements (e.g., facets) spaced apart from each other which may be inclined at an angle that may be one of oblique relative to at least one of second waveguide front surface 695 and a plane (e.g., an X-Z plane) that is perpendicular to second waveguide front surface 695. Illumination from the reflected at least one propagated image beam 665 may be received in a fourth direction (e.g., along a central axis of the second waveguide aperture expander 690) and then reflected in a fifth direction by the first plurality of partially reflecting optical elements in second waveguide first aperture expander 690 and conducted within second waveguide 688 as a second waveguide first plurality of expanded image beams X6B1 that may be directed to second waveguide second aperture expander 692. In this manner, the reflected at least one propagated image beam 665 illumination may be expanded in a first dimension (e.g., a third dimension) by the spaced apart facets to provide the first plurality of expanded image beams X6B1. A reflectivity of the third plurality of partially reflecting facets in second waveguide first aperture expander 690 may increase in a direction away from a second waveguide injection region WIR62, where the second waveguide first aperture expander 690 may have an initial facet with a lowest reflectivity and may terminate with a final facet that may be a mirror. Alternatively, a reflectivity of the third plurality of partially reflecting facets may be constant in a direction away from waveguide region WIR62 and, separate from this feature, may terminate with a final facet that may or may not be a mirror.

Similarly, second waveguide second aperture expander 692 may include a fourth plurality of planar, mutually-parallel and partially reflecting optical elements (e.g., facets) spaced apart from each other which may be inclined at an angle that may be one of oblique relative to at least one of second waveguide front surface 695 and a plane (e.g., an X-Z plane) that is perpendicular to second waveguide front surface 695. Illumination from the third plurality of expanded image beams X6B1 may be received in the fifth direction and then reflected in a sixth direction toward second waveguide rear surface 696 by the fourth plurality of partially reflecting optical elements in second waveguide second aperture expander 692. In this manner, illumination from third plurality of expanded image beams X6B1 may be expanded in a second dimension (e.g., a fourth dimension) by the spaced apart facets of second waveguide second aperture expander 692 to provide the second plurality of expanded image beams X6B2. In this manner, the plurality of expanded image beams X6B1 may be expanded in a second dimension that is different from the first dimension to provide a second plurality of expanded image beams X6B2. Thus, the second waveguide first aperture expander 690 and the second waveguide second aperture expander 692 may cooperate to provide a two-dimensional (2D) expansion of the reflected at least one propagated image beam 665 illumination as a second expanded output image beam 698 that may be emitted from second waveguide rear surface 696. Similar to second waveguide first aperture expander 690, a reflectivity of the fourth plurality of partially reflecting facets in second waveguide second aperture expander 692 may increase in a direction away from second waveguide first aperture expander 690, where the second waveguide second aperture expander 692 may have an initial facet with a lowest reflectivity and a final facet (e.g., a terminal facet) that is a mirror. Alternatively, a reflectivity of the fourth plurality of partially reflecting facets may be constant in a direction away from second waveguide first aperture expander 690 and, separate from this feature, may terminate with a final facet that may or may not be a mirror.

As described above, image projector 132 may provide a collimated image beam 610 that may be an illuminated representation of the digital image having an image field which is a two-dimensional representation of the digital image. Thus, first output image beam 612 and second output image beam 614 and others may propagate through various optical elements in optical system 100 as a two-dimensional (2D) image field about the illustrated central axes.

According to an example, first waveguide first aperture expander 678 and second waveguide first aperture expander 690 may be oriented parallel to each other, or either may be oriented perpendicular to each other. Other arrangements are also possible, where second waveguide first aperture expander 690 may be disposed on a side of second waveguide 688 that is farthest from (e.g., distal from) first waveguide 676. In this case, first waveguide 676 may be oppositely arranged about a diagonal axis 652 where first input aperture 678 may be arranged vertically above or below diagonal axis 652 as compared with FIG. 4A, for example. Similarly, second waveguide 688 may be oppositely arranged about a diagonal axis 658 where second input aperture 690 may be arranged vertically above or below diagonal axis 658 as compared with FIG. 4A, for example. Either first mirror 654 or second mirror 656 may include a coating configured to select two of the four images provided by the associated image pipe, for example. In some examples, first mirror 654 and/or second mirror 656 may not be used.

According to an example, coupling assembly 620 may also include an active half wave plate liquid crystal element (AHWP) 648 configured to receive the collimated image beam 610 and provide a transformed image beam 650. Active half wave plate liquid crystal element 648 may be an active optical element controlled by signals from controller 114 to selectively change polarity of at least a portion of collimated image beam 610 and provide transformed image beam 650, such as changing from an S-polarization to a P-polarization when activated, for example. In this example, polarizing beam splitter 622 first side 624 may receive transformed image beam 650 and provide first output image beam 612 from polarizing beam splitter 622 first side 624 and provide transmitted beam 628 from polarizing beam splitter second side 626. In this manner, optical device 602 may be practiced with or without active half wave plate liquid crystal element 648.

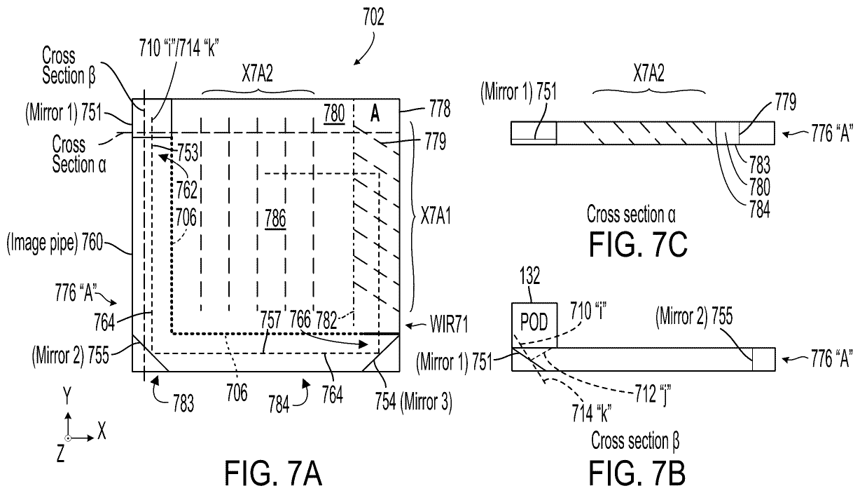

FIGS. 7A-7C illustrate details regarding an optical system, in accordance with various examples of the present disclosure. In particular, FIG. 7A illustrates a front plan view of an optical system 702, FIG. 7B illustrates a first cross section of optical system 702 taken along an X-Z plane identified as cross section α (alpha), and FIG. 7C illustrates a cross section of optical system 702 taken along a Y-Z plane identified as cross section β (beta), in accordance with various examples of the present disclosure.

According to an example, an optical device 702 may include an image pipe 760 integrated with a first waveguide 776 (Labeled as “A”). A portion of image pipe 760 may be affixed to a portion of first waveguide 776 using a low index of refraction (LRI) adhesive 706, for example. First waveguide 776 may have a first waveguide front surface 783 that is parallel with a first waveguide rear surface 784. In some examples, first waveguide 776 may directly receive a collimated image beam 710 (an “i” image beam) from a projecting optical device 132 to an image pipe input 762 of image pipe 760. In an example, first waveguide 776 may also include a first mirror 751 (e.g., a semitransparent mirror) configured to receive the collimated image beam 710 and provide a reflected image beam 753 to image pipe input 762 as a first output image beam 712 (e.g., a “j” image beam) and provide a transmitted beam as a second output image beam 714 (e.g., a “k” image beam) that may be applied to another waveguide or other optical element, for example. As will be described below, first waveguide 776 may be mounted against a second waveguide, for example. Similar to the description above, directly injected image beam 710 or reflected image beam 753 may be propagated within image pipe 760 as at least one first propagated image beam 764 to image pipe output 766. Within image pipe 760, the at least one first propagated image beam 764 may be received from a first direction and may be reflected in a second direction by a second mirror 755 to provide a first reflected at least one first propagated image beam 757 which may be further reflected by a third mirror 754 in a third direction (e.g., opposite to the first direction) to provide a second reflected at least one first propagated image beam 764 at image pipe output 766 that may be injected into first waveguide 776 at a waveguide injection region WIR71. Mirror 755 may be oriented such that it is normal to the front and rear surfaces of the waveguide, and oriented at a 45° angle relative to the side planes of the associated image pipe as compared with an X-axis within the X-Y plane, for example. In this manner, image pipe 760 may have multiple segments and mirrors to propagate an image beam around a portion of first waveguide 776 to a waveguide injection region WIR71 at a distance from projecting optical device 132.

First waveguide 776 (labeled as “A”) may include a first waveguide first aperture expander 778 and a first waveguide second aperture expander 780 separated from each other by a first waveguide dividing region 782. First waveguide first aperture expander 778 may include a first plurality of planar, mutually-parallel and partially reflecting optical elements (e.g., facets) spaced apart from each other which may be inclined at an angle that may be one of oblique relative to at least one of first waveguide front surface 783 and a plane (e.g., an X-Z plane) that is perpendicular to first waveguide front surface 783. Illumination from the reflected at least one first propagated image beam 764 may be received in a first direction (e.g., along a central axis of first waveguide aperture expander 778) and then reflected in a second direction and propagated within first waveguide 776 as a first waveguide first plurality of expanded image beams X7A1 that may be directed to first waveguide second aperture expander 780. In this manner, the reflected at least one first propagated image beam 764 illumination may be expanded in a first dimension by the spaced apart facets of first waveguide aperture expander 778 to provide the first plurality of expanded image beams X7A1. A reflectivity of the first plurality of partially reflecting facets in first waveguide first aperture expander 778 may increase in a direction away from waveguide injection region WIR71, where the first waveguide first aperture expander 778 may have an initial facet with a lowest reflectivity and may terminate with a final facet 779 that may be a fully reflective mirror. Alternatively, a reflectivity of the first plurality of partially reflecting facets may be constant in a direction away from waveguide region WIR71 and, separate from this feature, may terminate with a final facet 779 that may or may not be a mirror.

Similarly, first waveguide second aperture expander 780 may include a second plurality of planar, mutually-parallel and partially reflecting optical elements (e.g., facets) spaced apart from each other which may be inclined at an angle that may be one of oblique relative to at least one of first waveguide front surface 783 and a plane (e.g., an X-Z plane) that is perpendicular to first waveguide front surface 783. Illumination from the first plurality of expanded image beams X7A1 may be received in the second direction and then reflected in a third direction toward first waveguide rear surface 784 by the second plurality of partially reflecting optical elements in first waveguide second aperture expander 780. In this manner, illumination from first plurality of expanded image beams X7A1 may be expanded in a second dimension by the spaced apart facets of first waveguide second aperture expander 780 to provide the second plurality of expanded image beams X7A2. The plurality of expanded image beams X7A1 may be expanded in a second dimension that is different from the first dimension to provide a second plurality of expanded image beams X7A2. Thus, the first waveguide first aperture expander 778 and the first waveguide second aperture expander 780 may cooperate to provide a two-dimensional (2D) expansion of the reflected at least one first propagated image beam 764 illumination as a first expanded output image beam 786 that may be emitted from first waveguide rear surface 784. Similar to first waveguide first aperture expander 778, a reflectivity of the second plurality of partially reflecting facets in first waveguide second aperture expander 780 may increase in a direction away from first waveguide first aperture expander 778, where the first waveguide second aperture expander 780 may have an initial facet with a lowest reflectivity and a final facet that may be a mirror. Alternatively, a reflectivity of the first plurality of partially reflecting facets may be constant in a direction away from first waveguide first aperture expander 778 and, separate from this feature, may terminate with a final facet that may or may not be a mirror.

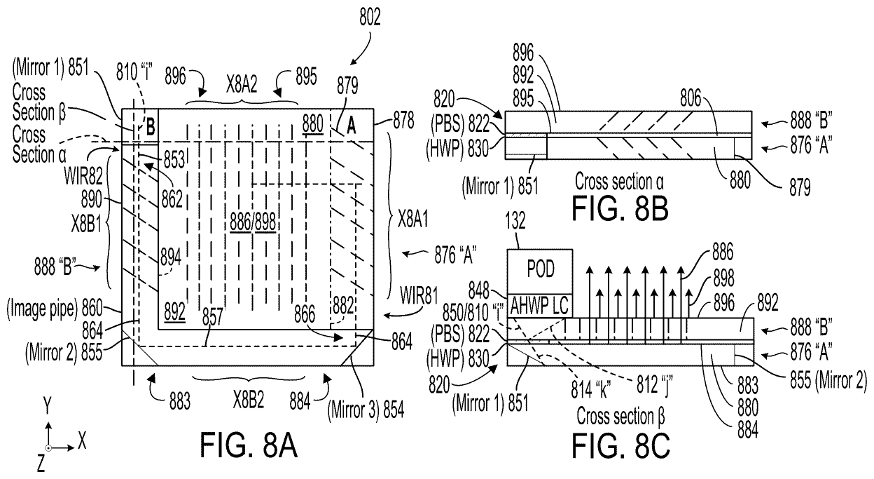

FIGS. 8A-8C illustrate details regarding an optical system, in accordance with various examples of the present disclosure. In particular, FIG. 8A illustrates a front plan view of an optical system 802, FIG. 8B illustrates a first cross section of optical system 802 taken along an X-Z plane identified as cross section α (alpha), and FIG. 8C illustrates a cross section of optical system 802 taken along a Y-Z plane identified as cross section β (beta), in accordance with various examples of the present disclosure.

According to an example, an optical device 802 may include an image pipe 860 integrated with a first waveguide 876 (Labeled as “A”). Optical device 802 may include a second waveguide 888 (Labeled as “B”) that may be affixed to a rear surface of first waveguide 876, and/or a portion of image pipe 860 may be affixed to a portion of first waveguide 876 using a low index of refraction (LRI) adhesive 806, for example. Optical device 802 may also include a coupling assembly 820 that may be disposed at least partially between a portion of first waveguide 876 and second waveguide 888. First waveguide 876 may have a first waveguide front surface 883 that is parallel with a first waveguide rear surface 884. Second waveguide 888 may have a second waveguide front surface 895 that is parallel with a second waveguide rear surface 896. In some examples, first waveguide 876 may directly receive a collimated image beam 810 (an “i” image beam) from a projecting optical device 132 to an image pipe input 862 of image pipe 860 and may be injected at an oblique angle relative to first waveguide major surfaces. In an example, first waveguide 876 may also include a first mirror 851 configured to receive the collimated image beam 810 and provide a reflected image beam 853 to image pipe input 862. Similar to the description above, directly injected image beam 810 or reflected image beam 853 may be propagated within image pipe 860 as at least one first propagated image beam 864 to image pipe output 866. Within image pipe 860, the at least one first propagated image beam 864 may be received from a first direction and may be reflected in a second direction by a second mirror 855 to provide a first reflected at least one first propagated image beam 857 which may be further reflected by a third mirror 854 in a third direction (e.g., opposite to the first direction) to provide a second reflected at least one first propagated image beam 864 at image pipe output 866 that may be injected into first waveguide 876 at a waveguide injection region WIR81. In this manner, image pipe 860 may have multiple segments and mirrors to propagate an image beam around a portion of first waveguide 876 to a waveguide injection region WIR81 at a distance from projecting optical device 132 and may enable injection of images (e.g., image beams) from previously unreached directions, for example.

Coupling assembly 820 may be positioned between a portion of second waveguide 888 and a portion of first waveguide 876 where collimated image beam 810 may be injected into a rear surface 896 of second waveguide 888. Coupling assembly 820 may include a polarizing beam splitter 822 having a first side and a second side. Coupling assembly 820 may also include a half wave plate 830 having a first side and a second side. Polarizing beam splitter 822 first side may be positioned adjacent to a portion of second waveguide 888 and configured to receive a portion of collimated image beam 810 injected at second waveguide rear surface 896. Polarizing beam splitter 822 may reflect a portion of collimated image beam 810 injected at second waveguide rear surface 896 having an S-polarization as a first output beam 812 (e.g., a “j” image beam) to be propagated within second waveguide 888 and to reflect from second waveguide front surface 895. Polarizing beam splitter 822 may transmit a portion of collimated image beam 810 that escapes second waveguide front surface 895 having P-polarization directed to half wave plate 830 first side which may convert the incident portion of collimated image beam 810 having P-polarization to now having S-polarization emitted from half wave plate second side and injected to first waveguide 876 rear surface 884 as a second output beam 814 (e.g., a “k” image beam) to be propagated within first waveguide 876.

First waveguide 876 (labeled as “A”) may include a first waveguide first aperture expander 878 and a first waveguide second aperture expander 880 separated from each other by a first waveguide dividing region 882. First waveguide first aperture expander 878 may include a first plurality of planar, mutually-parallel and partially reflecting optical elements (e.g., facets) spaced apart from each other which may be inclined at an angle that may be one of oblique relative to at least one of first waveguide front surface 883 and a plane (e.g., an X-Z plane) that is perpendicular to first waveguide front surface 883. Illumination from the reflected at least one first propagated image beam 864 may be received in a first direction (e.g., along a central axis of first waveguide aperture expander 878) and then reflected in a second direction and propagated within first waveguide 876 as a first waveguide first plurality of expanded image beams X8A1 that may be directed to first waveguide second aperture expander 880. In this manner, the reflected at least one first propagated image beam 864 illumination may be expanded in a first dimension by the spaced apart facets of first waveguide aperture expander 878 to provide the first plurality of expanded image beams X8A1. A reflectivity of the first plurality of partially reflecting facets in first waveguide first aperture expander 878 may increase in a direction away from waveguide injection region WIR81, where the first waveguide first aperture expander 878 may have an initial facet with a lowest reflectivity and may terminate with a final facet 879 that may be a fully reflective mirror. Alternatively, a reflectivity of the first plurality of partially reflecting facets may be constant in a direction away from waveguide region WIR81 and, separate from this feature, may terminate with a final facet 879 that may or may not be a mirror.

Similarly, first waveguide second aperture expander 880 may include a second plurality of planar, mutually-parallel and partially reflecting optical elements (e.g., facets) spaced apart from each other which may be inclined at an angle that may be one of oblique relative to at least one of first waveguide front surface 883 and a plane (e.g., an X-Z plane) that is perpendicular to first waveguide front surface 883. Illumination from the first plurality of expanded image beams X8A1 may be received in the second direction and then reflected in a third direction toward first waveguide rear surface 884 by the second plurality of partially reflecting optical elements in first waveguide second aperture expander 880. In this manner, illumination from first plurality of expanded image beams X8A1 may be expanded in a second dimension by the spaced apart facets of first waveguide second aperture expander 880 to provide the second plurality of expanded image beams X8A2. The plurality of expanded image beams X8A1 may be expanded in a second dimension that is different from the first dimension to provide a second plurality of expanded image beams X8A2. Thus, the first waveguide first aperture expander 878 and the first waveguide second aperture expander 880 may cooperate to provide a two-dimensional (2D) expansion of the reflected at least one first propagated image beam 864 illumination as a first expanded output image beam 886 that may be emitted from first waveguide rear surface 884. Similar to first waveguide first aperture expander 878, a reflectivity of the second plurality of partially reflecting facets in first waveguide second aperture expander 880 may increase in a direction away from first waveguide first aperture expander 878, where the first waveguide second aperture expander 880 may have an initial facet with a lowest reflectivity and a final facet that may be a mirror. Alternatively, a reflectivity of the first plurality of partially reflecting facets may be constant in a direction away from first waveguide first aperture expander 878 and, separate from this feature, may terminate with a final facet that may or may not be a mirror.

Second waveguide 888 (labeled as “B”) may include a second waveguide first aperture expander 890 and a second waveguide second aperture expander 892 separated from each other by a second waveguide dividing region 894. Second waveguide first aperture expander 890 may include a third plurality of planar, mutually-parallel and partially reflecting optical elements (e.g., facets) spaced apart from each other which may be inclined at an angle that may be one of oblique relative to at least one of second waveguide front surface 895 and a plane (e.g., an X-Z plane) that is perpendicular to second waveguide front surface 895. Illumination from the first output image beam 812 may be received in a fourth direction (e.g., along a central axis of the second waveguide aperture expander 890) and then reflected in a fifth direction by the first plurality of partially reflecting optical elements in second waveguide first aperture expander 890 and conducted within second waveguide 888 as a second waveguide first plurality of expanded image beams X8B1 that may be directed to second waveguide second aperture expander 892. In this manner, the first output image beam 812 illumination may be expanded in a first dimension (e.g., a third dimension) by the spaced apart facets to provide the first plurality of expanded image beams X8B1. A reflectivity of the third plurality of partially reflecting facets in second waveguide first aperture expander 890 may increase in a direction away from a second waveguide injection region WIR82, where the second waveguide first aperture expander 890 may have an initial facet with a lowest reflectivity and may terminate with a final facet that may be a mirror. Alternatively, a reflectivity of the third plurality of partially reflecting facets may be constant in a direction away from waveguide region WIR82 and, separate from this feature, may terminate with a final facet that may or may not be a mirror.

Similarly, second waveguide second aperture expander 892 may include a fourth plurality of planar, mutually-parallel and partially reflecting optical elements (e.g., facets) spaced apart from each other which may be inclined at an angle that may be one of oblique relative to at least one of second waveguide front surface 895 and a plane (e.g., an X-Z plane) that is perpendicular to second waveguide front surface 895. Illumination from the third plurality of expanded image beams X8B1 may be received in the fifth direction and then reflected in a sixth direction toward second waveguide rear surface 896 by the fourth plurality of partially reflecting optical elements in second waveguide second aperture expander 892. In this manner, illumination from third plurality of expanded image beams X8B1 may be expanded in a second dimension (e.g., a fourth dimension) by the spaced apart facets of second waveguide second aperture expander 892 to provide the second plurality of expanded image beams X8B2. In this manner, the plurality of expanded image beams X8B1 may be expanded in a second dimension that is different from the first dimension to provide a second plurality of expanded image beams X8B2. Thus, the second waveguide first aperture expander 890 and the second waveguide second aperture expander 892 may cooperate to provide a two-dimensional (2D) expansion of the first output image beam 812 illumination as a second expanded output image beam 898 that may be emitted from second waveguide rear surface 896. Similar to second waveguide first aperture expander 890, a reflectivity of the fourth plurality of partially reflecting facets in second waveguide second aperture expander 892 may increase in a direction away from second waveguide first aperture expander 890, where the second waveguide second aperture expander 892 may have an initial facet with a lowest reflectivity and a final facet (e.g., a terminal facet) that is a mirror. Alternatively, a reflectivity of the fourth plurality of partially reflecting facets may be constant in a direction away from second waveguide first aperture expander 890 and, separate from this feature, may terminate with a final facet that may or may not be a mirror. According to an example, first waveguide first aperture expander 878 and second waveguide first aperture expander 890 may be oriented parallel to each other. Other arrangements are also possible, where both first waveguide 876 and second waveguide 888 may be rotated.

As described above, second waveguide 888 may be configured to receive the first output image beam 812 and emit a second expanded output image beam 898 from second waveguide rear surface 896, and first waveguide 876 may be configured to receive the second output image beam 814 and emit a first expanded output image beam 886 from first waveguide rear surface 884. It is noted that first expanded output image beam 886 and second expanded image beam 898 are coincident and expanded separately from different directions, and both first expanded output image beam 886 and second expanded image beam 898 may be emitted toward an eye of a user to convey optical information. Hence, in this configuration first waveguide 876 with one embedded image pipe 860 along with an overlapping second waveguide 888 may cooperate to effectively double a field of view (FoV) provided by optical device 802 compared with a single waveguide example.

According to an example, coupling assembly 820 may also include an active half wave plate liquid crystal element (AHWP) 848 configured to receive the collimated image beam 810 and provide a transformed image beam 850. Active half wave plate liquid crystal element 848 may be an active optical element controlled by signals from controller 114 to selectively change polarity of at least a portion of collimated image beam 810 and provide transformed image beam 850, such as changing from an S-polarization to a P-polarization when activated, for example. A liquid crystal half wave plate may be a two-dimensional (2D) array of cells filled with liquid crystals that may twist and align in response to a control voltage. In this manner, active half wave plate liquid crystal element 848 may provide variable retardance (e.g., variable delay) by selectively tilting various liquid crystal molecules in the active half wave plate liquid crystal element 848, for example. The angle of tilt may be rapidly changed on the order of milliseconds. Similar to other examples described above, optical device 802 may be practiced with or without active half wave plate liquid crystal element 848.

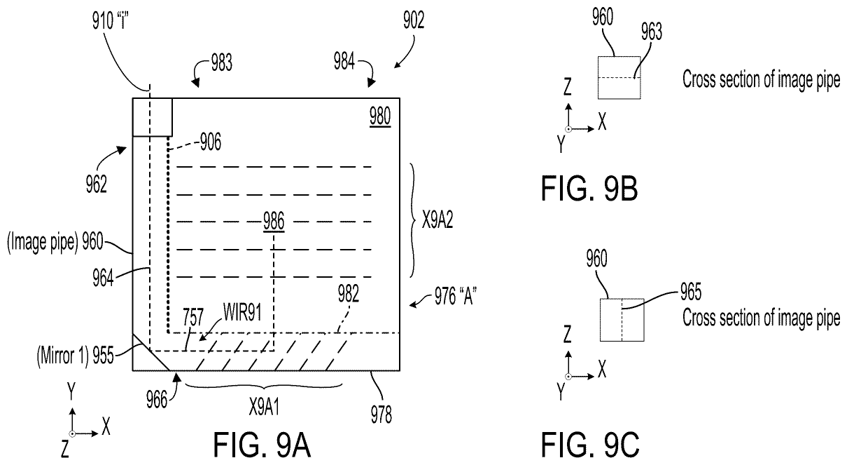

FIGS. 9A-9C illustrate details regarding an optical system, in accordance with various examples of the present disclosure. In particular, FIG. 9A illustrates a front plan view of an optical system 902, FIG. 9B illustrates a first cross section of an image pipe 960 taken along an X-Z plane illustrating a homogenizing layer 963 having a first orientation, and FIG. 9C illustrates a first cross section of an image pipe 960 taken along an X-Z plane illustrating a homogenizing layer 965 having a second orientation perpendicular to the first orientation, in accordance with various examples of the present disclosure.

According to an example, an optical device 902 may include an image pipe 960 integrated with a first waveguide 976 (Labeled as “A”). A portion of image pipe 960 may be affixed to a portion of first waveguide 976 using a low index of refraction (LRI) adhesive 906, for example. First waveguide 976 may have a first waveguide front surface 983 that is parallel with a first waveguide rear surface 984. In some examples, first waveguide 976 may directly receive a collimated image beam 910 (an “i” image beam) from a projecting optical device 132 (not shown) to an image pipe input 962 of image pipe 960. Similar to the description above, directly injected image beam 910 may be propagated within image pipe 960 as at least one first propagated image beam 964 to image pipe output 966. Within image pipe 960, the at least one first propagated image beam 964 may be received from a first direction and may be reflected in a second direction by a mirror 955 to provide a reflected at least one propagated image beam 957 at image pipe output 966 that may be injected into first waveguide 976 at a waveguide injection region WIR91. In this manner, image pipe 960 may propagate an input image beam to a waveguide injection region WIR91 at a distance from an image source, for example. FIG. 9B illustrates a first cross section of an image pipe 960 taken along an X-Z plane illustrating a homogenizing layer 963 having a first orientation, and FIG. 9C illustrates a first cross section of an image pipe 960 taken along an X-Z plane illustrating a homogenizing layer 965 having a second orientation perpendicular to the first orientation, in accordance with various examples of the present disclosure. Homogenizing layer 963 and/or homogenizing layer 965 may be formed as a coating layer or film along a length of image pipe 960 and disposed within image pipe 960. Homogenizing layer 963 and/or homogenizing layer 965 may improve illumination uniformity prior to expansion resulting in a more evenly illuminated and expanded image.

First waveguide 976 (labeled as “A”) may include a first waveguide first aperture expander 978 and a first waveguide second aperture expander 980 separated from each other by a first waveguide dividing region 982. First waveguide first aperture expander 978 may include a first plurality of planar, mutually-parallel and partially reflecting optical elements (e.g., facets) spaced apart from each other which may be inclined at an angle that may be one of oblique relative to at least one of first waveguide front surface 983 and a plane (e.g., an X-Z plane) that is perpendicular to first waveguide front surface 983. Illumination from the reflected at least one first propagated image beam 964 may be received in a first direction (e.g., along a central axis of first waveguide aperture expander 978) and then reflected in a second direction and propagated within first waveguide 976 as a first waveguide first plurality of expanded image beams X9A1 that may be directed to first waveguide second aperture expander 980. In this manner, the reflected at least one first propagated image beam 964 illumination may be expanded in a first dimension by the spaced apart facets of first waveguide aperture expander 978 to provide the first plurality of expanded image beams X9A1. A reflectivity of the first plurality of partially reflecting facets in first waveguide first aperture expander 978 may increase in a direction away from waveguide injection region WIR91, where the first waveguide first aperture expander 978 may have an initial facet with a lowest reflectivity and may terminate with a final facet that may be a fully reflective mirror. Alternatively, a reflectivity of the first plurality of partially reflecting facets may be constant in a direction away from waveguide region WIR91 and, separate from this feature, may terminate with a final facet that may or may not be a mirror.

Similarly, first waveguide second aperture expander 980 may include a second plurality of planar, mutually-parallel and partially reflecting optical elements (e.g., facets) spaced apart from each other which may be inclined at an angle that may be one of oblique relative to at least one of first waveguide front surface 983 and a plane (e.g., an X-Z plane) that is perpendicular to first waveguide front surface 983. Illumination from the first plurality of expanded image beams X9A1 may be received in the second direction and then reflected in a third direction toward first waveguide rear surface 984 by the second plurality of partially reflecting optical elements in first waveguide second aperture expander 980. In this manner, illumination from first plurality of expanded image beams X9A1 may be expanded in a second dimension by the spaced apart facets of first waveguide second aperture expander 980 to provide the second plurality of expanded image beams X9A2. The plurality of expanded image beams X9A1 may be expanded in a second dimension that is different from the first dimension to provide a second plurality of expanded image beams X9A2. Thus, the first waveguide first aperture expander 978 and the first waveguide second aperture expander 980 may cooperate to provide a two-dimensional (2D) expansion of the reflected at least one first propagated image beam 964 illumination as a first expanded output image beam 986 that may be emitted from first waveguide rear surface 984. Similar to first waveguide first aperture expander 978, a reflectivity of the second plurality of partially reflecting facets in first waveguide second aperture expander 980 may increase in a direction away from first waveguide first aperture expander 978, where the first waveguide second aperture expander 980 may have an initial facet with a lowest reflectivity and a final facet that may be a mirror. Alternatively, a reflectivity of the first plurality of partially reflecting facets may be constant in a direction away from first waveguide first aperture expander 978 and, separate from this feature, may terminate with a final facet that may or may not be a mirror. The homogenizing layer 963 having a first orientation illustrated in FIG. 9B and the homogenizing layer 965 having a second orientation illustrated in FIG. 9C may enable a reduced input aperture in some examples.

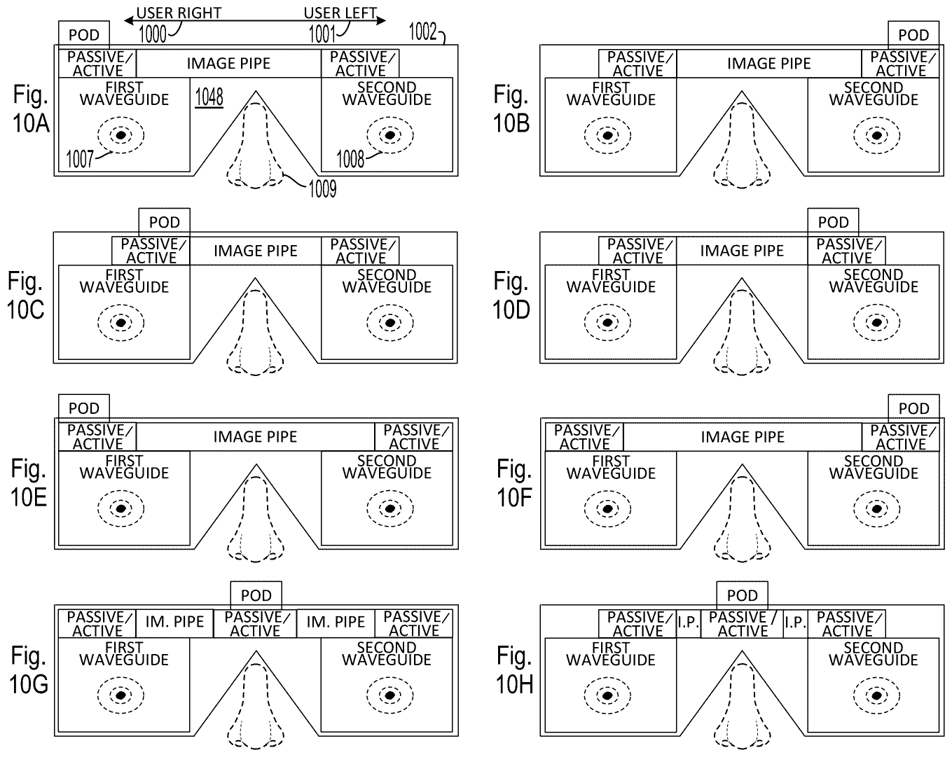

FIGS. 10A-10H illustrate details regarding various configurations of optical systems, in accordance with various examples of the present disclosure. Further, the optical systems illustrated in FIGS. 7A-7C, FIGS. 8A-8C, and FIGS. 9A-9C may be suitably combined with any of the optical systems illustrated in FIGS. 10A-10H. In this manner, each of the first waveguide and second waveguide illustrated in FIGS. 10A-10H may be either or both implemented as a single waveguide or a double waveguide, as described. Also, the orientation of some elements in various illustrations may be modified, swapped, rotated, reflected, or moved relative to similar elements in corresponding illustrations while retaining the same functions. It is intended that each of the features illustrated with the various examples may be combined in any manner that is consistent with the present disclosure.

FIG. 10A illustrates a front plan view of an optical system, in accordance with various examples of the present disclosure. In particular, FIG. 10A illustrates an optical system that may be similar in some ways to the optical systems illustrated in FIG. 3A and FIG. 4A. In this manner, FIG. 10B may illustrate an optical system that may be considered as a modified version of the optical system illustrated in FIG. 10A. In FIG. 10A and elsewhere, an eye (1007, 1008) and a nose 1009 of a user may be illustrated to provide a reference for how optical system 1002 may be worn on a head of a user and used to provide optical information, as described. For reference, a user right side 1000 and a user left side 1001 may indicate, from a user's perspective, a relative position of elements for optical system 1002, and others. A frame 1048 may be configured to support various elements of optical system 1002 such as a projecting optical device (POD), the coupling assembly with various passive and/or active elements, the one or more image pipes, the first waveguide and the second waveguide, and the like. Frame 1048 may be configured to conceal the one or more image pipes or other elements within a portion of the frame. In this manner, the one or more image pipes, will not be visible after optical system 1002 is assembled. FIG. 10C illustrates a front plan view of an optical system, in accordance with various examples of the present disclosure. Similarly, FIG. 10D may illustrate an optical system that may be considered as a modified version of the optical system illustrated in FIG. 10C.

Similarly, FIG. 10E illustrates a front plan view of an optical system, in accordance with various examples of the present disclosure. In particular, FIG. 10E illustrates an optical system that may be similar in some ways to the optical systems illustrated in FIG. 5A. In some ways, FIG. 10F may illustrate an optical system that may considered as a modified version of the optical systems illustrated in FIG. 10E.

Finally, FIG. 10H illustrates a front plan view of an optical system, in accordance with various examples of the present disclosure. In particular, FIG. 10H illustrates an optical system that may be similar in some ways to the optical systems illustrated in FIG. 6A. FIG. 10G illustrates a front plan view of an optical system, in accordance with various examples of the present disclosure. In particular, FIG. 10G illustrates an optical system that may also be similar in some ways to a modified version of the optical systems illustrated in FIG. 6A. In the example of FIG. 10G, longer image pipes may be used relative to the shorter image pipes (e.g., I.P.) shown in FIG. 10H so that a first injection point for a first image beam to a first waveguide may be located farther to a user right side and a second injection point for a second image beam to a second waveguide may be located farter to a user left side compared with corresponding injection points for the image beams illustrated in FIG. 10H or FIG. 6A, for example.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The various embodiments were chosen and described in order to best explain the principles of the invention and the practical application, and to enable others of ordinary skill in the art to understand the invention for various embodiments with various modifications as are suited to the particular use contemplated.

What is claimed is:

1. An optical device comprising:
a coupling assembly configured to receive a collimated image beam and provide a first output image beam and a second output image beam;
an image pipe configured to receive the first output image beam at an image pipe input and provide at least one propagated image beam at an image pipe output;
a first waveguide having a first waveguide rear surface, the first waveguide configured to receive the second output image beam and emit a first expanded output image beam from the first waveguide rear surface; and
a second waveguide having a second waveguide rear surface, the second waveguide configured to receive the at least one propagated image beam and emit a second expanded output image beam from the second waveguide rear surface.

2. The optical device of claim 1, wherein the coupling assembly further comprises:
a semitransparent mirror having a semitransparent mirror first surface and a semitransparent mirror second surface opposite the semitransparent mirror first surface, the semitransparent mirror first surface configured to receive the collimated image beam and provide the first output image beam reflected from the semitransparent mirror first surface and provide the second output image beam emitted from the semitransparent mirror second surface.

3. The optical device of claim 2,
wherein the first waveguide comprises a first waveguide first aperture expander and a first waveguide second aperture expander, the first waveguide first aperture expander being configured to expand the second output image beam and provide a first waveguide first plurality of expanded image beams directed to the first waveguide second aperture expander configured to expand the first waveguide first plurality of expanded image beams and provide a first waveguide second plurality of expanded image beams to be emitted as the first expanded output image beam; and
wherein the second waveguide comprises a mirror configured to receive the at least one propagated image beam and provide a reflected at least one propagated image beam, the second waveguide further comprising a second waveguide first aperture expander and a second waveguide second aperture expander, the second waveguide first aperture expander being configured to expand the reflected at least one propagated image beam and provide a second waveguide first plurality of expanded image beams directed to the second waveguide second aperture expander configured to expand the second waveguide first plurality of expanded image beams and provide a second waveguide second plurality of expanded image beams to be emitted as the second expanded output image beam.

4. The optical device of claim 3, further comprising:
an image projector configured to provide the collimated image beam based on a digital image, wherein the collimated image beam is collimated to infinity, and wherein the projector includes a liquid crystal on silicon display.

5. An optical system comprising:
an image projector configured to provide a collimated image beam based on a digital image;
a coupling assembly configured to receive the collimated image beam and provide a first output image beam and a second output image beam;
an image pipe configured to receive the first output image beam at an image pipe input and provide at least one propagated image beam at an image pipe output;
a first waveguide having a first waveguide rear surface, the first waveguide configured to receive the second output image beam and emit a first expanded output image beam from the first waveguide rear surface; and
a second waveguide having a second waveguide rear surface, the second waveguide configured to receive the at least one propagated image beam and emit a second expanded output image beam from the second waveguide rear surface.

6. The optical system of claim 5, wherein at least one of:
the collimated image beam is collimated to infinity;
the projector includes one of a liquid crystal display, a liquid crystal on silicon display, an organic light emitting diode display, a micro light emitting diode display, and a laser display;
the image pipe includes at least one of a glass material, an acrylic material, and a polycarbonate material;
a portion of the first waveguide is affixed to a portion of the image pipe with a layer of low refractive index adhesive; and
the image pipe is an elongated transparent member having a first end and a second end with a rectangular cross section and orthogonal walls, the image pipe configured to receive at least one input image beam and provide four replicated output image beams based on the at least one input image beam.

7. The optical system of claim 5,
wherein the coupling assembly comprises a semitransparent mirror having a semitransparent mirror first surface and a semitransparent mirror second surface opposite the semitransparent mirror first surface, the semitransparent mirror first surface configured to receive the collimated image beam and provide the first output image beam reflected from the semitransparent mirror first surface and to provide the second output image beam emitted from the semitransparent mirror second surface; and
wherein the first waveguide comprises a first waveguide first aperture expander and a first waveguide second aperture expander, the first waveguide first aperture expander being configured to expand the second output image beam and provide a first waveguide first plurality of expanded image beams directed to the first waveguide second aperture expander configured to expand the first waveguide first plurality of expanded image beams and provide a first waveguide second plurality of expanded image beams to be emitted as the first expanded output image beam; and
wherein the second waveguide comprises a mirror configured to receive the at least one propagated image beam and provide a reflected at least one propagated image beam, the second waveguide further comprising a second waveguide first aperture expander and a second waveguide second aperture expander, the second waveguide first aperture expander being configured to expand the reflected at least one propagated image beam and provide a second waveguide first plurality of expanded image beams directed to the second waveguide second aperture expander configured to expand the second waveguide first plurality of expanded image beams and provide a second waveguide second plurality of expanded image beams to be emitted as the second expanded output image beam.

8. The optical system of claim 5, wherein the coupling assembly comprises:
a polarizing beam splitter having a polarizing beam splitter first side and a polarizing beam splitter second side opposite the polarizing beam splitter first side, the polarizing beam splitter first side being configured to receive the collimated image beam and provide the first output image beam from the polarizing beam splitter first side and provide a transmitted image beam from the polarizing beam splitter second side; and
a half wave plate having a half wave plate first side and a half wave plate second side, the half wave plate being configured to receive the transmitted image beam at the half wave plate first side and provide the second output image beam from the half wave plate second side.

9. The optical system of claim 8,
wherein the first waveguide comprises a first waveguide first aperture expander and a first waveguide second aperture expander, the first waveguide first aperture expander being configured to expand the second output image beam and provide a first waveguide first plurality of expanded image beams directed to the first waveguide second aperture expander configured to expand the first waveguide first plurality of expanded image beams and provide a first waveguide second plurality of expanded image beams to be emitted as the first expanded output image beam; and
wherein the second waveguide comprises a second waveguide first aperture expander and a second waveguide second aperture expander, the second waveguide first aperture expander being configured to expand the at least one propagated image beam and provide a second waveguide first plurality of expanded image beams directed to the second waveguide second aperture expander configured to expand the second waveguide first plurality of expanded image beams and provide a second waveguide second plurality of expanded image beams to be emitted as the second expanded output image beam.

10. The optical system of claim 5, wherein the coupling assembly further comprises:
an active half wave plate liquid crystal element configured to receive the collimated image beam and provide a transformed image beam;
a polarizing beam splitter having a polarizing beam splitter first side and a polarizing beam splitter second side opposite the polarizing beam splitter first side, the polarizing beam splitter first side being configured to receive the transformed image beam and provide the first output image beam from the polarizing beam splitter first side and provide a transmitted image beam from the polarizing beam splitter second side; and
a half wave plate having a half wave plate first side and a half wave plate second side, the half wave plate being configured to receive the transmitted image beam on the half wave plate first side and provide the second output image beam from the half wave plate second side.

11. The optical system of claim 10,
wherein the first waveguide comprises a first waveguide first aperture expander and a first waveguide second aperture expander, the first waveguide first aperture expander being configured to expand the second output image beam and provide a first waveguide first plurality of expanded image beams directed to the first waveguide second aperture expander configured to expand the first waveguide first plurality of expanded image beams and provide a first waveguide second plurality of expanded image beams to be emitted as the first expanded output image beam; and
wherein the second waveguide comprises a mirror configured to receive the at least one propagated image beam and provide a reflected at least one propagated image beam, the second waveguide further comprising a second waveguide first aperture expander and a second waveguide second aperture expander, the second waveguide first aperture expander being configured to expand the reflected at least one propagated image beam and provide a second waveguide first plurality of expanded image beams directed to the second waveguide second aperture expander configured to expand the second waveguide first plurality of expanded image beams and provide a second waveguide second plurality of expanded image beams to be emitted as the second expanded output image beam.

12. The optical system of claim 10,
wherein the first waveguide comprises a first waveguide first aperture expander and a first waveguide second aperture expander, the first waveguide first aperture expander being configured to expand the second output image beam and provide a first waveguide first plurality of expanded image beams directed to the first waveguide second aperture expander configured to expand the first waveguide first plurality of expanded image beams and provide a first waveguide second plurality of expanded image beams to be emitted as the first expanded output image beam; and
wherein the second waveguide comprises a second waveguide first aperture expander and a second waveguide second aperture expander, the second waveguide first aperture expander being configured to expand the at least one propagated image beam and provide a second waveguide first plurality of expanded image beams directed to the second waveguide second aperture expander configured to expand the second waveguide first plurality of expanded image beams and provide a second waveguide second plurality of expanded image beams to be emitted as the second expanded output image beam.

13. The optical system of claim 10, wherein the image pipe is a first image pipe and wherein the first waveguide includes a first waveguide front surface that is opposite the first waveguide rear surface, the optical system further comprising:
a third waveguide having a third waveguide rear surface, the third waveguide configured to receive the second output image beam and emit a third expanded output image beam from the third waveguide rear surface, the third waveguide rear surface being affixed to the first waveguide front surface, the third waveguide comprising:
a second image pipe configured to receive the second output image beam and provide at least one propagated third image beam at a third image pipe output;
a third waveguide first aperture expander, the third waveguide first aperture expander configured to expand the at least one propagated third image beam and provide a third waveguide first plurality of expanded image beams; and
a third waveguide second aperture expander configured to expand the first plurality of expanded image beams and provide a third waveguide second plurality of expanded image beams to be emitted as the third expanded output image beam, the second image pipe configured to surround at least a portion of the third waveguide second aperture expander.

14. The optical system of claim 5, further comprising:
a frame configured to support the image projector, the coupling assembly, the image pipe, the first waveguide and the second waveguide, the frame being configured to conceal the image pipe within a portion of the frame.

15. An optical system comprising:
an image projector configured to provide a collimated image beam based on a digital image;
a coupling assembly configured to receive the collimated image beam and provide a first output image beam and a second output image beam;
a first image pipe configured to receive the first output image beam at a first image pipe input and provide an at least one first propagated image beam at a first image pipe output;
a second image pipe configured to receive the second output image beam at a second image pipe input and provide an at least one second propagated image beam at a second image pipe output;
a first waveguide having a first waveguide rear surface, the first waveguide configured to receive the at least one second propagated image beam and emit a first expanded output image beam from the first waveguide rear surface; and
a second waveguide having a second waveguide rear surface, the second waveguide configured to receive the at least one first propagated image beam and emit a second expanded output image beam from the second waveguide rear surface.

16. The optical system of claim 15, wherein the coupling assembly comprises:
an active half wave plate liquid crystal element configured to receive the collimated image beam and provide a transformed image beam;
a polarizing beam splitter having a polarizing beam splitter first side and a polarizing beam splitter second side opposite the polarizing beam splitter first side, the polarizing beam splitter first side being configured to receive the transformed image beam and provide the second output image beam from the polarizing beam splitter first side and provide a transmitted image beam from the polarizing beam splitter second side;
a quarter wave plate having a quarter wave plate first side and a quarter wave plate second side, the quarter wave plate being configured to receive the transmitted image beam on the quarter wave plate first side and provide a converted image beam from the quarter wave plate second side; and
a mirror having a reflective mirror surface configured to receive the converted image beam and provide a reflected image beam, the quarter wave plate configured to receive the reflected image beam on the quarter wave plate second side and provide a second converted image beam from the quarter wave plate first side, the polarizing beam splitter configured to receive the second converted image beam on the polarizing beam splitter second side and provide the first output image beam.

17. The optical system of claim 16,
wherein the first waveguide comprises a first mirror configured to receive the at least one second propagated image beam and provide a reflected at least one second propagated image beam, the first waveguide further comprising a first waveguide first aperture expander and a first waveguide second aperture expander, the first waveguide first aperture expander being configured to expand the reflected at least one second propagated image beam and provide a first waveguide first plurality of expanded image beams directed to the first waveguide second aperture expander configured to expand the first waveguide first plurality of expanded image beams and provide a first waveguide second plurality of expanded image beams to be emitted as the first expanded output image beam; and
wherein the second waveguide comprises a second mirror configured to receive the at least one first propagated image beam and provide a reflected at least one first propagated image beam, the second waveguide further comprising a second waveguide first aperture expander and a second waveguide second aperture expander, the second waveguide first aperture expander being configured to expand the reflected at least one first propagated image beam and provide a second waveguide first plurality of expanded image beams directed to the second waveguide second aperture expander configured to expand the second waveguide first plurality of expanded image beams and provide a second waveguide second plurality of expanded image beams to be emitted as the second expanded output image beam.

18. The optical system of claim 15, wherein the first waveguide includes a first waveguide front surface that is opposite the first waveguide rear surface, the optical system further comprising:
a third waveguide having a third waveguide rear surface, the third waveguide configured to receive the at least one second propagated image beam and emit a third expanded output image beam from the third waveguide rear surface, the third waveguide rear surface being affixed to the first waveguide front surface, the third waveguide comprising:
a third image pipe configured receive the at least one second propagated image beam and provide an at least one propagated third image beam at a third image pipe output;
a third waveguide first aperture expander, the third waveguide first aperture expander configured to expand the at least one propagated third image beam and provide a third waveguide first plurality of expanded image beams; and
a third waveguide second aperture expander configured to expand the first plurality of expanded image beams and provide a third waveguide second plurality of expanded image beams to be emitted as the third expanded output image beam, the second image pipe configured to surround at least a portion of the third waveguide second aperture expander, the second image pipe having a homogenizing layer.

19. The optical system of claim 18, wherein the second waveguide includes a second waveguide front surface that is opposite the second waveguide rear surface, the optical system further comprising:
a polarizing beam splitter having a polarizing beam splitter first side and a polarizing beam splitter second side opposite the polarizing beam splitter first side, the polarizing beam splitter first side being configured to receive the at least one first propagated image beam and provide a second transmitted image beam from the polarizing beam splitter second side;
a half wave plate having a half wave plate first side and a half wave plate second side, the half wave plate being configured to receive the second transmitted image beam on the half wave plate first side and provide a second converted image beam from the half wave plate second side;
a fourth waveguide having a fourth waveguide rear surface, the fourth waveguide configured to receive the second converted image beam and emit a fourth expanded output image beam from the fourth waveguide rear surface, the fourth waveguide rear surface being affixed to the second waveguide front surface, the fourth waveguide comprising:
a fourth image pipe configured to receive the second converted image beam and provide an at least one propagated fourth image beam at a fourth image pipe output;
a fourth waveguide first aperture expander, the fourth waveguide first aperture expander configured to expand the at least one propagated first image beam and provide a fourth waveguide first plurality of expanded image beams; and
a fourth waveguide second aperture expander configured to expand the fourth plurality of expanded image beams and provide a fourth waveguide second plurality of expanded image beams to be emitted as the fourth expanded output image beam, the fourth image pipe configured to surround at least a portion of the fourth waveguide second aperture expander, the fourth image pipe including a homogenizing layer.

20. The optical system of claim 15, further comprising:
a frame configured to support the image projector, the coupling assembly, the first image pipe, the second image pipe, the first waveguide and the second waveguide, the frame being configured to conceal the first image pipe and the second image pipe within a portion of the frame.
